(19) United States
(12) Patent Application Publication
(10) Pub. No.: US 2026/0084624 A1
(43) Pub. Date: Mar. 26, 2026

(54) SMARTSAFE TRAY ASSEMBLY

(71) Applicant: SMARTSAFE CONSOLE, LLC, Las Vegas, NV (US)

(72) Inventor: TARKAN BASTIYALI, New York, NY (US)

(73) Assignee: SMARTSAFE CONSOLE, LLC, Las Vegas, NV (US)

(21) Appl. No.: 19/400,875

(22) Filed: Nov. 25, 2025

Related U.S. Application Data
(63) Continuation-in-part of application No. 18/962,754, filed on Nov. 27, 2024.
Application No. 18/962,754 is a continuation-in-part of application No. 18/606,099, filed on Mar. 15, 2024, now Pat. No. 12,275,303.
Application No. 18/606,099 is a continuation-in-part of application No. 18/152,814, filed on Jan. 11, 2023, now Pat. No. 12,049,134.
Application No. 18/152,814 is a continuation-in-part of application No. 17/661,608, filed on May 2, 2022, now Pat. No. 12,071,099.
Application No. 17/661,608 is a continuation-in-part of application No. 17/650,354, filed on Feb. 8, 2022, now Pat. No. 12,377,785.

(51) Int. Cl. B60R 7/04; B60K 28/04; B60K 35/234; B60K 35/25; B60K 35/26; B60R 25/20; B60R 25/22; B60R 25/24; B60W 40/08; B60W 40/09; B60W 50/14; B60W 50/16

(52) U.S. Cl. CPC B60R 7/04; B60K 28/04; B60K 35/234; B60K 35/25; B60K 35/265; B60R 25/209; B60R 25/22; B60R 25/24; B60W 40/09; B60W 50/16; B60K 2360/119; B60K 2360/1438; B60K 2360/148; B60K 2360/164; B60K 2360/166; B60K 2360/188; B60W 2040/0818; B60W 2050/143; B60W 2050/146; B60W 2540/21

(57) ABSTRACT

A SmartSafe tray or cassette assembly for vehicles is disclosed, comprising a smartphone docking slot and a controller configured to permit vehicle ignition only upon authorized docking. The system integrates with vehicle infotainment and head-up display (HUD) interfaces to project navigation, route, and media data. It provides haptic, visual, and audible alerts for route updates, fuel level, and safety conditions. The assembly supports voice commands for destination confirmation, includes AI-based driver monitoring, event data recording, and anti-theft synchronization. The tray further enables wireless charging, multi-mode operation via restricted or unrestricted key fobs, and compatibility with cars, scooters, e-bikes, and helmets featuring HUD projection.

### CLAIM OF PRIORITY

This application is a continuation-in-part of U.S. application Ser. No. 18/962,754, filed Nov. 27, 2024, entitled “Smart Safe Console System”, which is a continuation-in-part of U.S. application Ser. No. 18/606,099, filed Mar. 15, 2024, entitled “Smart Safe Console System”, which is a continuation-in-part of U.S. patent application Ser. No. 18/152,814, filed on Jan. 11, 2023, entitled “Smart Safe Console System”, which is a continuation-in-part of U.S. patent application Ser. No. 17/661,608, filed May 2, 2022, entitled “Smart Safe Console System”, which is a continuation-in-part of U.S. patent application Ser. No. 17/650,354, filed Feb. 8, 2022, entitled “Smart Safe Console System”, the contents of all of which are hereby incorporated by reference in their entirety.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The present invention relates generally to the field of vehicle safety of existing art and more specifically relates to containment systems for electronic devices.

### BACKGROUND

Electronic devices like phones, tablets, smart glasses, and the like are becoming increasingly common in modern times. Such devices can be used for a variety of tasks including messaging, phone conversations, social media, navigation, photography, etc. With so many features offered on electronic devices, many people struggle to stop using the device during necessary times such as operating a vehicle. Many vehicle accidents are a result from distractions caused by electronic devices which is dangerous for public road safety.

Prior attempts to solve this problem include inhibiting all features and communications to and from the electronic device. However, the electronic devices offer a variety of resources that can be useful to a user or operator. Further, family members or friends can become worried when a message or phone call is not returned. Therefore, a suitable solution is required.

Existing efforts to limit distraction often rely on software blocks or in-vehicle infotainment constraints, but rarely enforce a physical interlock requiring the phone to be docked or verify driver sobriety before allowing vehicle operation. Further, while advanced driver assistance systems (ADAS) and related safety systems (e.g., ASAS) are gaining adoption in cars and trucks (for collision avoidance, lane-keeping, etc.), these systems typically do not automatically intervene in response to incoming messages or calls.

Thus, there is an unmet need for a unified smart safe console/docking system that spans multiple vehicle types, enforces safe-driving interlocks (including intoxication detection), integrates with ADAS/ASAS systems to suppress or manage distractions (texts and calls), and offers seamless navigation feedback (e.g. helmet HUD), while also providing monitoring, usage-based compensation, and emergency override capabilities.

### SUMMARY OF THE INVENTION

The present disclosure provides for a method for preventing unsafe operation of a vehicle. First, a console system mounted within the vehicle, comprising an assembly configured to be mounted within a vehicle, a safe body permanently attached to the assembly, the safe body being configured to secure an electronic device against physical access therein, the safe body comprising a tray sized to hold the electronic device, the safe body having an open state and a closed state, when the electronic device is secured within the safe body is provided. Here, the closed state restricts physical access to the electronic device within the safe body, the open state allows physical access to the electronic device within the safe body, the safe body is in electronic communication with the electronic device, and the safe body is configured to communicate with the vehicle.

This method then continues to the step of registering, by the user, the electronic device with the console system such that the electronic device and the console system may be in wireless electronic communication. The user then places the electronic device within the safe body and moves the safe body into the closed position, thereby preventing the user from accessing the electronic device. The user then proceeds to fasten their seatbelt resulting in a signal being transmitted from the console system to the vehicle, indicating that the electronic device is secured within the safe body. Upon receipt of this signal, operation of the vehicle is permitted.

Embodiments exist where this method requires the performance of some sort of verification protocol in order for the console system to permit operation of the vehicle. In various embodiments, this includes the fastening of one or more seatbelts, either by the driver alone or by all occupants. Additionally, operation of the vehicle, in the context of the present disclosure can mean starting the vehicle and/or shifting the transmission into the drive setting or otherwise permitting the vehicle to be driven. This verification protocol can also include assessments for whether the user's speech is slurred, or whether the user is otherwise intoxicated.

Embodiments exist where the system in accordance with the present disclosure can be configured to have a “teenage mode” whereby a user and a super user are both registered to use said system. In these embodiments the super user is able to bypass the restrictions by utilizing an authenticated device or entering an authorization code. In such embodiments, the super user can be presented with report of driving by the user containing statistics about the user's operation of the vehicle. These statistics can include minimum speed, maximum speed, maximum audio volume, location, maximum acceleration, time of operation, and duration of operation.

For a console system for use in a vehicle, to allow for safer operation of such vehicle. In some embodiments, the console system includes an assembly configured to be mounted within a vehicle, a safe body permanently attached to the assembly, a time clock, and a charging apparatus configured to charge the electronic device, when the electronic device is secured within the safe body. In some embodiments the safe body is configured to secure an electronic device against physical access therein. Embodiments exist where the safe body comprises a tray sized to hold the electronic device, and the safe body has an open state and a closed state, where the closed state restricts physical access to the electronic device within the safe body, and where the open state allows physical access to the electronic device within the safe body.

In some embodiments, the safe body is configured to remotely interface with a remote source and configured to allow a user to record time spent in the vehicle. Embodiments exist where the safe body also includes an interface screen viewable from an exterior of the safe body, where the interface screen is in electronic communication with the time clock. In such embodiments, the interface screen can be configured to display any of a start time, an expected end time, and a timer showing a differential between the start time and a present time. Embodiments exist where the timer is provided by a remote source, such as an employer of the user. In various embodiments the timer may be analog or digital. In some embodiments the time clock is configured to register with electronic device such that, while registered, the console system operates exclusively with the registered electronic device. Preferably, the console system is configured to prevent the vehicle from being used unless the electronic device is placed within the safe body and the safe body is in the closed state.

The present disclosure provides for embodiments of a console system for use in vehicles, including an assembly configured to be mounted within a vehicle and a safe body configured to secure an electronic device against physical access therein. In an embodiment, the safe body includes a tray sized to hold the electronic device. In an embodiment, the safe body has an open state and a closed state. In an embodiment, the closed state restricts physical access to the electronic device within the safe body. In an embodiment, the open state allows physical access to the electronic device within the safe body. In an embodiment, the safe body is in electronic communication with the electronic device. In an embodiment, the safe body is configured to communicate with the vehicle. In an embodiment, the console system includes a charging apparatus configured to charge the electronic device, when the electronic device is secured within the safe body.

The present disclosure also provides for embodiments of a console system for use in a vehicle which comprises an assembly configured to be mounted within a vehicle, a safe body permanently attached to the assembly, the safe body being configured to secure an electronic device against physical access therein, where the safe body comprises a tray sized to hold the electronic device and has an open state and a closed state. In these embodiments, the closed state restricts physical access to the electronic device within the safe body and the open state allows physical access to the electronic device within the safe body. In some embodiments the safe body is in electronic communication with the electronic device and is configured to communicate with the vehicle. Embodiments exist where the console system includes a time clock, configured to remotely interface with a remote source and configured to allow a user to record time spent in the vehicle. This time clock can be a physical time clock accessed via an interface screen, the interface screen being disposed on the exterior of the safe body, or can be a digital time clock which users access through an electronic device such as a smartphone. In embodiments where this smartphone is secured within the safe body, the time clock is engaged prior to the smartphone being placed within the safe body. In various embodiments, the time block can display a start time, an expected end time, and a timer showing a differential between the start time and a present time. In some embodiments, these various times are provided by a remote source, such as an employer of the user. Embodiments exist where the time clock is registered with an electronic device such that, while registered, the console system operates exclusively with the registered electronic device.

The present disclosure also provides for a method of promoting safe operation of a vehicle. Embodiments exist where the method begins by first providing a console system mounted within the vehicle, where the console system features an assembly configured to be mounted within a vehicle, features a safe body permanently attached to the assembly, which is configured to secure an electronic device against physical access therein and includes a tray sized to hold the electronic device. This safe body has both an open state and a closed state, as well as a button disposed on an exterior of the console system. When the safe body is in a closed state, physical access to the electronic device is restricted, and when the safe body is in an open state, physical access to the electronic device is permitted. The safe body is configured to communicate with the vehicle and the button, safe body, and electronic device are all in electronic communication.

After this safe body is provided, an embodiment of the method in accordance with the present disclosure proceeds to registering, by the user, the electronic device with the console system such that the electronic device, the safe body may be in wireless electronic communication. Embodiments of the method in accordance with the present disclosure can proceed to the step of engaging the button, by a user, to initialize a verification protocol, which is then performed by the user.

Various verification protocols are contemplated by the present disclosure. In various embodiments, these verification protocols can assist with the prevention of theft of the vehicle, can assist with the prevention of operating the vehicle while the user is impaired by drugs, alcohol, or drowsiness. In embodiments where the verification protocol is configured to assist with the prevention of theft of the vehicle, the verification protocol begins by creating, by a remote server in wireless electronic communication with the electronic device, a verification code which is then delivered to the electronic device. In these embodiments, a user then enters the verification code into a software application on the electronic device the authenticity of which is verified by the software application. If the verification is authenticated by the software application, an authorization signal is transmitted to the safe body. Upon receipt of the authorization code, a user is then able to press the button on the safe body, which results in the safe body being in the open position.

For some embodiments where the verification protocol is configured to assist with the prevention of operation of the vehicle while the user is impaired, the verification protocol begins by creating, by a remote server in wireless electronic communication with the electronic device, a security query which is then delivered to the electronic device. In these embodiments, a user then performs the steps prompted by the security query. In some embodiments, the security query comprises a digital puzzle which must be completed by the user. In other embodiments, the security query consists of questions which must be answered audibly. In these embodiments, the electronic device is equipped with software that can detected slurred speech by the user. In other embodiments the security query comprises one or more math problems which are to be solved by the user. In some embodiments the console system is equipped with a breathalyzer and in those embodiments the security query will require that user to blow into the breathalyzer to ensure that the user's BAC is below the legal limit. In these various embodiments, upon completion of the security query an authorization signal is transmitted to the safe body. Upon receipt of the authorization code, the safe body is moved into an open position where the user may then place their electronic device within the safe body.

Embodiments exist where after the verification protocol has been performed by the user, the user then places the electronic device within the safe body. In these embodiments the safe body is moved into the closed position, thereby preventing the user from accessing the electronic device. Once secured within the safe body, the console system transmits an unlock signal to the vehicle, which in turn permits driving operation of the vehicle.

In an embodiment, the smart safe console system includes an interface screen viewable from an exterior of the safe body.

In an embodiment, the tray includes a spring mounted tray, a locking mechanism, and a slot configured to accept the electronic device.

In an embodiment, the slot is accessible to a user and the locking mechanism is disengaged when the safe body is in its open state, and wherein the slot is inaccessible to the user and the locking mechanism is engaged when the safe body is in its closed state.

In an embodiment, the locking mechanism is configured to engage when the safe body is transitioned from the open state to the closed state.

In an embodiment, the locking mechanism is configured to disengage when the safe body is transitioned from the closed state to the open state.

In an embodiment, the tray is configured to eject the electronic device when the safe body is transitioned from the closed state to the opened state.

In an embodiment, the safe body is configured to prevent the vehicle from being used unless the electronic device is placed within the tray via the slot and the safe body is in the closed state.

In an embodiment, the electronic device is one or more electronic devices.

The claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features or embodiments.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### BRIEF DESCRIPTION OF THE ACCOMPANYING DRAWINGS

In the drawings, like elements are depicted by like reference numerals. The drawings are briefly described as follows.

FIG. 1 is a perspective view of the smart safe console system during an ‘in-use’ condition, according to an embodiment of the present disclosure.

FIG. 2 is a perspective cutaway view of the smart safe console system of FIG. 1, according to an embodiment of the present disclosure.

FIG. 3 is a perspective view of the smart safe console system of FIG. 1, according to an embodiment of the present disclosure.

FIG. 4 is a front view of the smart safe console system of FIG. 1, according to an embodiment of the present disclosure.

FIG. 5 is a flow diagram illustrating a method of using a smart safe console system, according to an embodiment of the present disclosure.

FIG. 6 is a perspective view of the handheld device of the override apparatus of the smart safe console system, according to an embodiment of the present disclosure.

FIG. 7 is a perspective view of the smart safe console system, according to an alternate embodiment of the present disclosure.

FIG. 8 is an overhead view of an illustration of the external user being notified of a request to override the smart safe console system, according to an embodiment of the present disclosure.

FIG. 9 is an overhead view of an illustration of the external user granting a request to override the smart safe console system in response to the request of FIG. 8, according to an embodiment of the present disclosure.

FIG. 10 is a perspective view of the first keyhole of the smart safe console system, according to an embodiment of the present disclosure.

FIG. 11 is a perspective view of the second keyhole of the smart safe console system, according to an embodiment of the present disclosure.

FIG. 12 is a top view of the tray of the smart safe console system, according to an embodiment of the present disclosure.

FIG. 13 is a perspective view of the tray of the smart safe console system, disposed within an interior of the smart safe console system, according to an embodiment of the present disclosure.

FIG. 14 is a perspective view of the tray of the smart safe console system in an open state, with the electronic device contained within, according to an embodiment of the present disclosure.

FIG. 15 is a perspective view of the tray of the smart safe console system in an open state, according to an embodiment of the present disclosure.

FIG. 16 is a perspective view of the smart safe console system, according to an embodiment of the present disclosure.

FIG. 17 is a perspective view of an alternate embodiment of the smart safe console system, illustrating a display screen.

FIG. 18 shows a top view of a graphical user interface of a software application which interfaces with the same safe console system of the present disclosure.

FIG. 19 shows a flow chart of an embodiment of a method for using a smart safe console system of the present disclosure.

FIG. 20A shows a flow chart of an embodiment of the verification protocol of the present disclosure.

FIG. 20B shows a flow chart of a second embodiment of the verification protocol of the present disclosure.

FIG. 20C shows a flow chart of a third embodiment of the verification protocol of the present disclosure.

FIG. 21A is a perspective view of a smart tray assembly, in accordance with an embodiment of the present invention.

FIG. 21B illustrates the smart tray assembly having a smartphone docked in the slot of the tray, in accordance with an embodiment of the present invention.

FIG. 22A illustrates an open state of the tray integrated in a dashboard of a vehicle, in accordance with an embodiment of the present invention.

FIG. 22B illustrates a closed state of the tray integrated in the dashboard of the vehicle, in accordance with an embodiment of the present invention.

FIG. 23 illustrates an AI camera integrated with the smart tray assembly, in accordance with an embodiment of the present invention.

FIG. 24 shows a head-up display feature integrated into the smart tray assembly, in accordance with an embodiment of the present invention.

FIG. 25 illustrates a system level block diagram of the Smart tray assembly, configured to control vehicle operation and provide driver monitoring, infotainment integration, and usage-based compensation functionality, in accordance with an embodiment of the present invention.

FIG. 26 illustrates a logic flow diagram depicting the conditional interlock sequence for enabling vehicle drive mode under Teen Driver Mode, generally activated when the Teen Key Fob is in use, in accordance with an embodiment of the present invention.

FIG. 27 illustrates an exemplary user interface of a Driver Behavior Monitoring Dashboard, configured for display on a mobile device, tablet, or in-vehicle infotainment system, in accordance with an embodiment of the present invention.

FIG. 28 illustrates a graphical user interface (GUI) display for the Punch Clock module that forms part of the compensation logic unit described in FIG. 5, in accordance with an embodiment of the present invention.

FIGS. 29A and 29B illustrates the tray assembly mounted on a two-wheeler, such as a motorcycle or a scooter, in accordance with an exemplary embodiment of the present invention.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DETAILED DESCRIPTION OF THE PREFERRED EMBODIMENTS

Reference will now be made in detail to each embodiment of the present invention. Such embodiments are provided by way of explanation of the present invention, which is not intended to be limited thereto in any manner whatsoever. In fact, those of ordinary skill in the art may appreciate upon reading the present specification and viewing the present drawings that various modifications and variations can be made thereto.

For purposes of the present disclosure of the invention, unless specifically disclaimed, the singular includes the plural and vice-versa, the words “and” and “or” shall be both conjunctive and disjunctive, the words “any” and “all” shall both mean “any and all”.

As discussed above, embodiments of the present disclosure relate to containment systems for electronic devices and more particularly to a smart safe console system and method as used to improve vehicle safety while utilizing features on electronic devices.

Generally, the present invention includes a console which may be compatible with a variety of electronic devices such as smart phones, smart watches, and smart glasses. The system may be installed in the area between an operator and a passenger, typically called the ‘middle console’ in any vehicle such as a train, boat, truck, or car, or even airborne vehicle such as air taxi/flying taxi. The area between an operator and a passenger may also be a center console armrest in some embodiments. With the electronic devices locked away in the present invention, the operator can manipulate the vehicle with their full attention and any passengers do not have to worry if the operator is texting on the electronic device, on a social media site, or otherwise distracted.

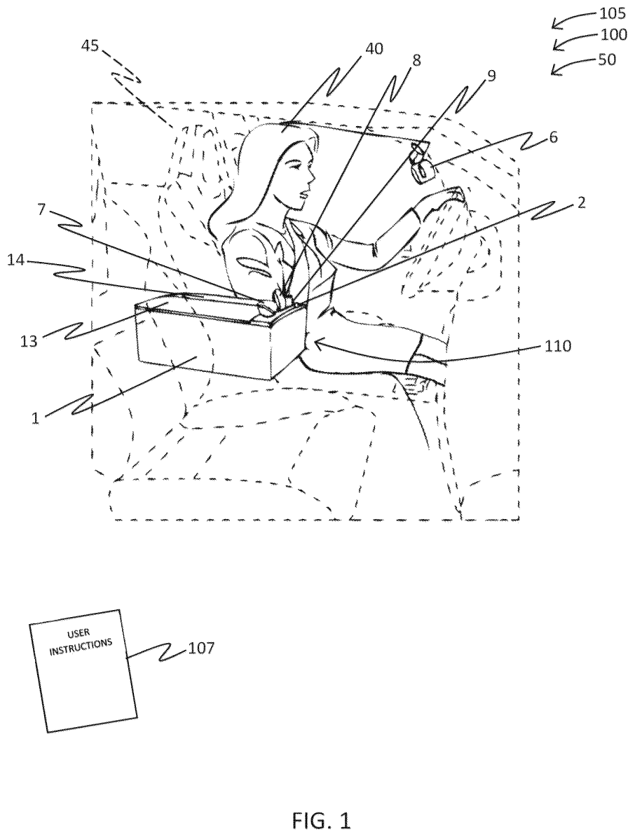

Referring now more specifically to the drawings by numerals of reference, there is shown in FIGS. 1-4, various views of a smart safe console system 100.

FIG. 1 shows smart safe console system 100 during an ‘in-use’ condition 50, according to an embodiment of the present disclosure. Here, the smart safe console system 100 may be beneficial for use by an operator 40 to improve vehicle safety in relation to the use of electronic devices 21. As illustrated, the smart safe console system 100 may comprise a smart safe console assembly 110 including a smart safe body 1 suitable to house at least one electronic device 21. The electronic device 21 may be able to be isolated from hand-held use by the smart safe body 1.

The smart safe console assembly 110 may also include an engager-button 2 configured for controlling input and output communications to and from the electronic device 21 (e.g., text messages) when a vehicle 45 hosting the smart safe console system 100 is in use. The smart safe console assembly 110 may be in communication with a provider and/or with the vehicle 45 and may be configured to control use of the electronic device 21 in relation to manipulation of the vehicle 45.

The provider may provide cellular-phone-service (e.g., phone carriers), internet service (e.g., wireless communication network) to the electronic device 21. Those with ordinary skill in the art will now appreciate that upon reading this specification and by their understanding the art of communications with the electronic device 21 as described herein, methods of restraining, manipulating, providing, safely limiting will be understood by those knowledgeable in such art.

The vehicle 45 may host the smart safe console system 100 such that the smart safe console assembly 110 may be hardwired to the circuitry of the vehicle 45. The vehicle 45 may provide an energy source (e.g. vehicle battery) for powering the smart safe console system 100. Alternatively, the smart safe console assembly 110 may include a self-contained battery for powering the smart safe console system 100. The smart safe console system 100 may be powered by AC power distributed throughout the smart safe console assembly 110 by a DC power supply (e.g. vehicle battery). Other powering means may be used. Hardwired and non-hardwired versions may be employed.

The smart safe console assembly 110 may be in communication with sensors on the vehicle 45 with the sensors able to sense at least one condition of the vehicle 45. The at least one condition of the vehicle 45 may be measured via a proximity sensor, a motion sensor, a speed sensor, an audio sensor, an impact sensor, or combination thereof. The sensors may provide one or more functions for the smart safe console assembly 110 such as sending an automatically generated message from the electronic device 21 to a desired recipient when the impact sensor is sensed. The impact sensor may indicate that an accident to the vehicle 45 has occurred. The desired recipient can be a family member, friend, or third-party (i.e., police). Sensing means may vary.

The smart safe console system 100 may further comprise at least one cigarette socket 3 along an exterior-portion of the smart safe body 1 configured for communicating and powering one or more external electrical accessories with the smart safe console assembly 110.

Another aspect of the present invention may provide for a software application (SW App) that is hosted on the electronic device 21. The software application may be downloaded on the electronic device's 21 memory and be configured to register and facilitate communication between the electronic device 21 and the smart safe console assembly 110. In some embodiments, the registration includes a verification process between the electronic device 21 and the smart safe console assembly 110, preferably where the smart safe console assembly 110 includes a verification button, when depressed, facilitates the verification process, more preferably where the verification button allows the electronic device 21 to sync with the smart safe console assembly 110. In some embodiments, the registration process and/or verification process includes connecting one or both of the smart safe console assembly 110 and the electronic device 21 to a wireless internet hotspot. In an exemplary embodiment, the smart safe console assembly 110 broadcasts a WIFI hotspot for the electronic device 21 to connect to, preferably where the hotspot is named with a name that indicates its connection to the smart safe console assembly 110. In an exemplary embodiment, the registration and/or verification process includes one or more of the steps of: 1) depressing the verification button on the smart safe console assembly 110; 2) sending a message from the smart safe console assembly 110 to the electronic device 21, using the WIFI hotspot, where the message indicates that the registration and/or verification process has begun, and preferably sets a time limit for response and/or sets a verification code or message that must be sent to the smart safe console assembly to complete registration or verification; 3) sending a verification code or message to the smart safe console assembly, whether digitally using the WIFI hotspot from the electronic device 21, or manually; and 4) depressing the verification button again to complete registration and/or verification. In such embodiments, the smart safe console assembly opens to allow access after the registration and/or verification process is completed. In some embodiments, use of the software application is necessary for the proper functioning of the smart safe console assembly 110, and the software application is configured to run on a subscription-based system. Where the smart safe console assembly 110 is being used with more than one electronic device 21, whether individually or simultaneously, the user may choose which electronic device to sync with the smart safe console assembly 110.

The operator 40 may register to the software application by a phone number or other known identification means associated with the electronic device 21. The registration process may further include registration of emergency contact information, such as, but not limited to, emergency contact phone numbers, medical information, contact information for physicians or doctors associated with the user, addresses, and others. The software application may be linked to the cellular-phone-service such that the phone number can be stored in a national database operated by the cellular-phone-service. The software application may be in communication with the vehicle 45 hosting the smart safe console system 100 such that one or more operations (e.g., unlocking the vehicle 45, rolling down windows, etc.) can be performed to the vehicle 45 from the software application. Further, the software application may allow for personalization of features equipped with the smart safe console assembly 110. In some embodiments, the smart safe console system 100 communicates specific commands to the software application when the safe is opened, such as a command to remind the user to update the software application and allows the signals containing the update material to communicate with the electronic device 21 while the electronic device 21 is secured within the smart safe console assembly 110. In some embodiment, updating occurs when the electronic device 21 is charging in the smart safe console assembly 110. In other embodiments, updating can occur in the smart safe console assembly 110 when the electronic device 21 is not charging.

Embodiments exist where the Smart Safeconsole system 100 is equipped with a time clock. In such embodiments the user could be an employee who is required to operate the vehicle as part of their employment, and the employer may want safeguards to ensure the company vehicle is being operated properly. In such embodiments, an exemplary method of use is as follows. First, a console system mounted within the vehicle is provided. Here, the console system comprises an assembly configured to be mounted within a vehicle, a safe body permanently attached to the assembly, the safe body being configured to secure an electronic device against physical access therein, the safe body comprising a tray sized to hold the electronic device, the safe body having an open state and a closed state, a time clock, configured to remotely interface with a remote source and configured to allow a user to record time spent in the vehicle, a charging apparatus configured to charge the electronic device. Here, when the electronic device is secured within the safe body, the closed state restricts physical access to the electronic device within the safe body and the open state allows physical access to the electronic device within the safe body. In these embodiments, the safe body is in electronic communication with the electronic device, and is configured to communicate with the vehicle. The electronic device may be registered, by the user, with the console system such that may be in wireless electronic communication with the electronic device. The user then places the electronic device within the safe body and then the safe body is moved the closed position, thereby preventing the user from accessing the electronic device.

Once the electronic device is secured within the safe body, a signal is transmitted from the console system to the vehicle, indicating that the electronic device is secured within the safe body. This signal is transmitted, either directly or indirectly, to an immobilization device in the vehicle. Such a device can be the gearbox of the vehicle where the vehicle simply remains in the “park” position, or it can be a separate component in the car specially configured to prevent movement of the vehicle. Upon receipt of this signal, the immobilization device will allow for the vehicle to be operated.

In some embodiments, the equipped timer is what triggers a second signal to be sent to the immobilization device such that the safe body may be transitioned to the open position. Such a timer can be provided by a remote source, such as an employer of the user, and can correlate to the user's shift. Such a timer can run the full length of the shift, or can be configured to permit for various breaks during the shift, such as a lunch break.

According to one embodiment, the smart safe console system 100 may be arranged as a kit 105. In particular, the smart safe console system 100 may further include a set of instructions 107. The instructions 107 may detail functional relationships in relation to the structure of the smart safe console system 100 such that the smart safe console system 100 can be used, maintained, or the like, in a preferred manner.

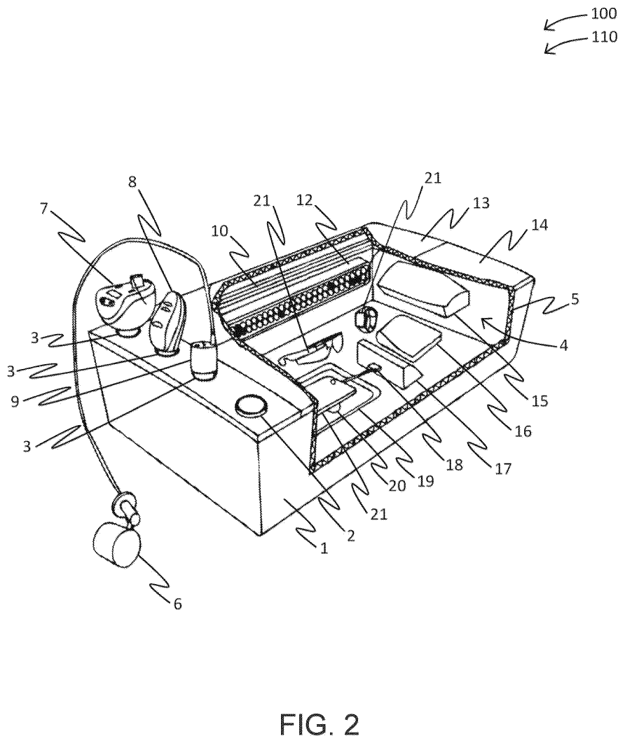

FIG. 2 shows the smart safe console system 100 of FIG. 1, according to an embodiment of the present disclosure. As above, the smart safe console system 100 may include the smart safe console assembly 110 including the smart safe body 1 suitable to house the at least one electronic device 21. The electronic device 21 may be able to be isolated from hand-held use by the smart safe body 1.

The smart safe console assembly 110 may also include the engager-button 2 configured for controlling input and output communications to and from the electronic device 21 when the vehicle 45 hosting the smart safe console system 100 is in use. The smart safe console assembly 110 may be in communication with the provider and with the vehicle 45 and may be configured to control use of the electronic device 21 in relation to manipulation of the vehicle 45. The provider may provide one or more of: cellular-phone-service, internet service, and/or vehicle navigation services, such as those offered through Apple® or Google® as part of Apple Maps® or Google Maps®, to the electronic device 21. The input and output communications may include sending text or voice recorded messages.

In various embodiments, the system in accordance with the present disclosure can be configured to provide an estimated time of arrival to a third party who texts the electronic device secured within the safe body. That is, the navigation services in electronic communication with the electronic device will determine the estimated amount of time it will take for the vehicle to arrive at an entered destination, taking into account distance, average speed, speed limits, and real-time traffic data. The system in accordance with the present invention shall then automatically respond with this estimated time of arrival to the third party who sent a text message to the secured electronic device. In some embodiments, an additional user-customized message will also be automatically sent to said third party.

The smart safe console assembly 110 may further comprise at least one cigarette socket 3 along the exterior-portion of the smart safe body 1 configured for communicating and powering one or more external electrical accessories with the smart safe console assembly 110. The external electrical accessories include a transmitter 7, a virtual assistant device 9, a fragrance emitter 8, or combination thereof. The at least one cigarette socket 3 may communicably connect to the smart safe console assembly 110 such that the external electrical accessories are in communication with the provider and with the vehicle 45. Each of the external electrical accessories may be connected (with an adapter) or otherwise equipped with a rearward protruding electrode for contacting a powered electrical contact within the cigarette socket 3.

In some embodiments, the smart safe body 1 is configured to have an opened state 340 and a closed state 350. In some embodiments, the smart safe body 1 further includes a left-wing 13 and a right-wing 14 configured to move between an opened-state and a closed-state. In other embodiments, alternate configurations for the smart safe body which allow for such opening and closing are also envisioned, such as a shutter mechanism which slides to move between the opened-state and the closed-state, either from top to bottom, or left to right, in a diaphragm configuration, or any other equivalent means as known in the art. When in the opened-state, the electronic device 21 may be inserted or removed from the smart safe body 1. When in the closed-state, the electronic device 21 may be isolated from hand-held use. The left-wing 13 and the right-wing 14 may include a liner 5. Furthermore, the liner 5 may extend around the entire smart safe body 1. The liner 5 comprises of a sound-proofing material and is configured to dampen and inhibit sounds from the electronic device 21 from reaching the operator 40 of the vehicle 45. Sounds generated from the electronic device 21 may distract the operator 40 unless otherwise dampened.

In some embodiments, the smart safe body 1 may include a tray 300. Preferably, the tray 300 is configured, sized, and/or shaped to hold the electronic device 21. In some embodiments, the tray 300 is shaped to completely enclose the electronic device 21. In such embodiments, the electronic device 21 may be inserted into the tray 300 through a slot 320. In other embodiments, the tray 300 does not completely enclose the electronic device 21, and thus the electronic device 21 may be inserted into the tray 300 from an open side. In an exemplary embodiment, the tray 300 comprises a recessed flush piece shaped similarly to a cassette player. In an embodiment, the tray 300 may hold the electronic device 21 in any orientation, including horizontal and vertical orientations. In preferable embodiments, the tray 300 is configured to hold the electronic device 21 in a snug fit, and/or includes or is lined with materials that conform tightly to the shape of the electronic device 21. Such materials may include any flexible materials suitable for such use, such as EPDM rubber. In an exemplary embodiment, the tray 300 includes holders, straps, or restraints intended to fit and/or secure the electronic device 21. In many embodiments, the tray 300 is configured to hold a wide array of types of electronic devices 21 of all shapes and sizes. In some embodiments, the tray 300 may be made, at least partially, out of a material that dampens sounds, or shields electromagnetic radiation.

Preferably, the tray 300 is configured to charge the electronic device 21 when the electronic device 21 is placed within the tray 300, more preferably using wireless charging technologies. In many embodiments, the tray 300 is configured to interface with and/or be in electronic communication with the electronic device 21 through wireless technologies, but in some embodiments, the tray 300 may include wired means of interfacing or being in communication with the electronic device 21, such as USB cables, audio cables, power cables and/or outlets, or other such connection methods. In some embodiments, the tray 300 may be configured, sized, and/or shaped to hold and/or accept one or more electronic devices 21, such as one or more of: a mobile phone, a tablet, a smart watch, a pair of smart glasses, wireless earphones, any other smart device, or any combination of one or more of the preceding. In some embodiments, the tray 300 interacts with the other functions and/or components of the smart safe assembly 110, such that charging of the electronic device 21 only begins once other components have been activated. For example, the tray 300 may require sync with the software application, or entry of the driver's information, including emergency contact information, before charging is enabled.

In some embodiments, the smart safe body 1, and/or the surface of the tray 300, may include an interface screen 330. Such interface screen 330 may display icons for useful applications for use by the user. Such interface screen 330 is preferably touch sensitive, although specialized buttons or other equivalent UI may be used. In some embodiments, the interface screen 330 displays icons for applications such as Waze, Google Maps, music applications, voice-to-text applications, phone call applications, etc. Preferably, the smart safe body 1, and/or components thereof, communicate with the vehicle 45 such that an application selected by the user on the interface screen 330 is displayed on a screen of a dashboard of the vehicle 45. In more preferable embodiments, a plurality of applications chosen by the user on the interface screen 330 may be displayed on a screen of a dashboard of the vehicle 45 simultaneously, such as through split screen displays. In some embodiments, any application, or graphical display capable of being visualized by the electronic device 21 may also be played on a dashboard of the vehicle 34 through the use of the smart safe body 1, preferably through the use of Bluetooth technologies.

In some embodiments, the tray 300 includes a spring mount, pneumatic mount, or other such device 310 configured to displace the tray 300. In an exemplary embodiment, the spring mount 310 may displace the slot 320, or other opening of the tray 300, above the plane of the opening of the smart safe body 1, when the smart safe body 1 is in its opened state 340. In some embodiments, the spring mount 310 may displace the slot 320, or other opening of the tray 300, such that it is recessed into the smart safe body 1, when the smart safe body 1 is in its closed state 350, such that such slot 320, or other opening of the tray is inaccessible to the user. In some embodiments the tray 300 includes a locking mechanism to hold the tray 300 in such inaccessible state when the smart safe body 1 is in its closed state 350.

In some embodiments, the tray 300 may use “push-push” technology and function similarly to devices such as cassette players utilizing such technology. For instance, the tray 300 may begin in a state where the slot 320, or other opening of the tray 300, is accessible to the user, preferably where the smart safe body 1 is in its opened state 340. When the user places the electronic device 21 within the slot 320, or other opening of the tray 300, and presses upon the surface of the tray 300 and/or surface of the smart safe body 1, the tray 300 becomes recessed within the smart safe body 1 such that the slot 320, or other opening of the tray 300, becomes inaccessible to the user, thereby securing the electronic device 21 from the user. Preferably, the smart safe body 1 transitions to the closed state 350 and/or the locking mechanism engages when the tray 300 is depressed by the user. In some embodiments, beginning from a state where the tray 300 is recessed into the smart safe body 1, and/or the slot 320, or other opening of the tray 300 is inaccessible to the user, the user may press one or more times upon the surface of the tray 300 and/or smart safe body 1 to transition the tray 300 into a state where the slot 320, or other opening of the tray 300, is accessible to the user. Preferably, such pressing upon the surface of the tray 300 and/or surface of the smart safe body 1 disengages the locking mechanism and/or transitions the smart safe body 1 to the opened state 340. In some embodiments, the spring mount 310 functions and/or is configured to displace the tray between the state where the slot 320, or other opening of the tray 300, is accessible and the state where the slot 320, or other opening of the tray 300 is inaccessible to the user. The spring mount 310 may also function or aid in transitioning the smart safe body 1 between the opened state 340 and the closed state 350. In an exemplary embodiment, the smart safe body 1 is configured to prevent use of the vehicle 45 by the user unless the electronic device 21 is placed within the tray 300, preferably such that the tray 300 is charging the electronic device 21, and the tray 300 is recessed into the smart safe body 1 and/or the smart safe body 1 is in its closed state 350.

In some embodiments, when the tray 300 transitions into a state where the slot 320, or other opening of the tray 300, is accessible to the user, and/or when the smart safe body 1 transitions from the closed state 350 to the opened state 340, the tray is configured to eject the electronic device 21 from the tray, the electronic device 21 is contained within the tray 300, preferably through the slot 320 or other opening of the tray 300. In some embodiments, when the electronic device 21 is contained within the tray 300 and/or the electronic device 21 is being charged by the tray 300, and the tray 300 is inaccessible to the user and/or the smart safe body is in its closed state 350, the interface screen 330 is configured to display an indicator of such status. In preferable embodiments, the interface screen 330 includes a specialized indicator light, configured to display a colored light, such as a green light, to indicate such status, but in other embodiments, a screen of the interface screen 330 may instead display such indicator. In some embodiments, the smart safe body 1, and/or the tray 300, may include a breathalyzer, preferably where the breathalyzer may be interacted with through an application on the smart safe body 1, the interface screen 330, and/or the electronic device 21. Where the embodiment includes a breathalyzer, preferably the smart safe console assembly 110 is configured such that it prevents use of the vehicle 45 by the user, unless the user blows into the breathalyzer and the breathalyzer indicates that the user is below a predetermined blood alcohol level. Such breathalyzer requirement may be in combination with any other requirements disclosed herein for use of the vehicle by the user.

In some embodiments, the smart safe body 1, and/or the liner 5, and/or the tray 300, may include at least one material with electromagnetic radiation shielding properties. Such electromagnetic shielding properties include, for example, the property of preventing wireless electronic communication with an electronic device placed within the smart safe body. In some embodiments, the electromagnetic shielding properties thus include shielding of one or more of any radio frequencies utilized by electronic devices to communicate, such as, but not limited to, frequency bands associated with the following technological standards: GSM, UMTS, LTE, 5G NR, and CDMA. Such frequency bands may include radio frequencies in the ranges of 800-6000 MHz. In some embodiments, the electromagnetic shielding properties may include shielding any other number of frequencies associated with technologies which electronic devices use to communicate, such as Bluetooth, wireless LAN, RFID, and others. In some embodiments, the material with electromagnetic radiation shielding properties has an effectiveness obtained for the present graphemes infused TPU material of 5 to 10 DB.

In some embodiments, the smart safe body 1, and/or the liner 5, and/or the tray 300, may include at least one material with antiviral properties. Such antiviral properties may include, for example, the properties of killing and/or inactivating any viruses and/or virus particles which come into contact with the interior or exterior of the smart safe assembly, preferably in less than 60 minutes, more preferably where at least 99.9999% of such virus is destroyed and/or inactivated. In such embodiments, the material may exhibit its antiviral properties through inducing, either directly or indirectly, the degradation of viral genetic material. Examples of viruses killed and/or inactivated include SARS-COV-2, any other virus associated with COVID-19, or any other viruses. Exemplary embodiments of the at least one material with electromagnetic shielding properties and/or the at least one material with antiviral properties may be found in U.S. application Ser. No. 16/802,830, entitled “Urethane and Graphene Interior Trim Panel”, filed Feb. 27, 2020, the entirety of which is hereby incorporated by reference. Such materials may include any material suitable for building the smart safe body with antiviral or antiseptic properties, such as “Fortvi” plastic.

In some embodiments, the smart safe body 1 may include a wireless charging apparatus configured to charge the electronic device, when the electronic device is placed within the safe body. Such wireless charging apparatus may use any such wireless charging technologies for charging electronic devices, such as wireless inductive charging, as may be known in the art. In exemplary embodiments, inductive charging technology standards, such as Qi and/or PMA may be used.

The smart safe body 1 may include an interior-housing 4 defined by one or more walls, the left-wing 13, and the right-wing 14. The smart safe body 1 can be provided in a variety of shapes and sizes that fit in the vehicle 45. For example, the smart safe body 1 may include a curved surface on one or more walls or be substantially rectangular/squared. The interior-housing 4 may be equipped with an apparatus configured to emit sanitizing radiation, such as ultraviolet light, into the interior of the safe body, when the safe body is closed. In an exemplary embodiment, the interior-housing 4 may be equipped with an ultraviolet light disinfecting device 12 configured to destroy and/or inactivate one or more of: bacteria, viruses, yeast, or other pathogens, on one or more surfaces housed within the smart safe body 1. In an exemplary embodiment, the sanitizing radiation emitted by the apparatus is sufficient to destroy or inactivate SARS-COV-2. The interior-housing 4 may further be equipped with a sunglasses holder 15, a wallet holder 16, a charging unit 17, a docking station 19, an electromagnetic field (EMF) battery 20, colored LED light strips 10, or combination thereof. The colored LED light strips 10 may be customized (i.e., changing of light colors) via the SW App. Additionally, other features may be equipped in the interior-housing not shown in FIG. 2, such as a cooling fan, when desired.

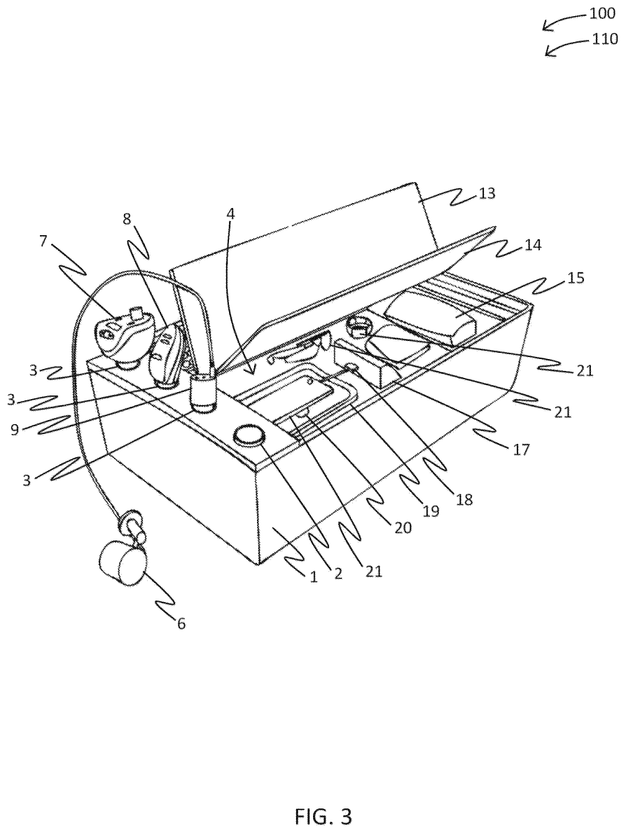

FIG. 3 is a perspective view of the smart safe console system 100 of FIG. 1, according to an embodiment of the present disclosure. As noted above, the smart safe body 1 includes the left-wing 13 and the right-wing 14 configured to move between the opened-state and the closed-state. When in the opened-state, the electronic device 21 may be inserted or removed from the smart safe body 1. When in the closed-state, the electronic device 21 may be isolated from hand-held use. The left-wing 13 and the right-wing 14 may open on opposite sides (as shown) or they may open on the same side.

The smart safe body 1 may further include the interior-housing 4 defined by one or more walls, the left-wing 13, and the right-wing 14. The interior-housing 4 may be equipped with the charging unit 17 including an electrical connector 18 (e.g., USB socket and/or plug) for connecting the electronic device 21 to be charged, and the docking station 19 for holding the electronic device 21 proximate the charging unit 17 and the electrical connector 18. The interior-housing 4 may further be equipped with the electromagnetic field (EMF) battery 20 positioned below the docking station 19 and is configured prevent radiation from emitting from the electronic device 21 when housed within the smart safe body 1.

The smart safe assembly 110 may be in communication with a control module configured to permit non-operation of the vehicle 45 when the electronic device 21 is not in a sensed-condition, and operation of the vehicle 45 when the electronic device 21 is in the sensed-condition. The sensed-condition may be when the electronic device 21 is electrically connected to the charging unit 17, and the left-wing 13 and the right-wing 14 is in the closed-state. The charging unit 17, and the left-wing 13 and the right-wing 14 may include at least one operation sensor coupled to the control module. The at least one operation sensor may be configured to detect the sensed-condition and send to the control module upon receipt of the sensed-condition. It should be noted that the electronic device 21 may be required to be registered with the software application prior to receipt of the sensed-condition such that all electronic devices 21 can be accounted for.

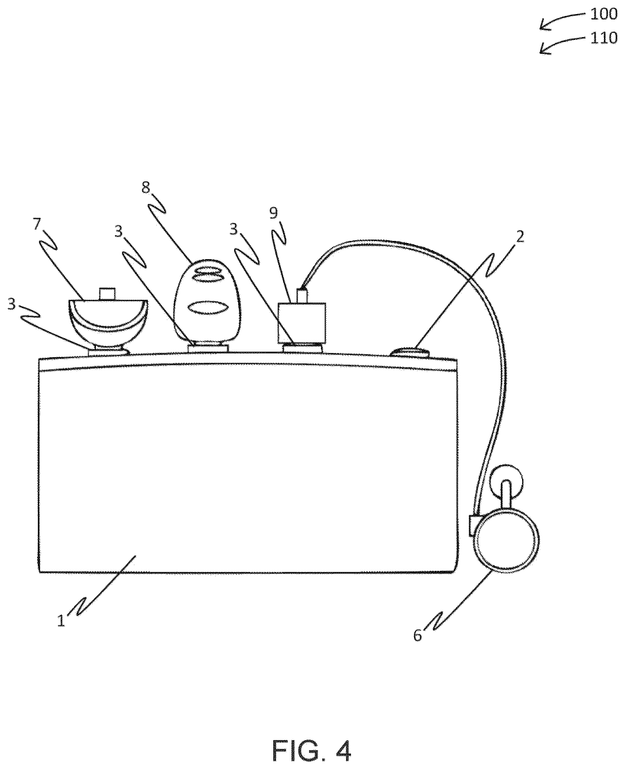

FIG. 4 is a front view of the smart safe console system 100 of FIG. 1, according to an embodiment of the present disclosure. The smart safe console assembly 110 may comprise the at least one cigarette socket 3 along the exterior-portion of the smart safe body 1 configured for communicating and powering the one or more external electrical accessories with the smart safe console assembly 110. The external electrical accessories may include the transmitter 7, the virtual assistant device 9, and the fragrance emitter 8. The fragrance emitter 8 may be configured to emit one or more scents within the vehicle 45. The fragrance emitter 8 may continually emit scents or periodically on a timer. Other features may be included.

In some embodiments, the virtual assistant may be hosted entirely on the smart safe assembly or on the electronic device itself. However, in other embodiments, the virtual assistant may be hosted in a separate device. The virtual assistant device 9 may be in communication with the electronic device 21 (hosting the software application) and the engager-button 2 and is configured to enable voice input communication and voice output communication between the virtual assistant device 9 and the electronic device 21 when a signal is received from the engager-button 2. Commonly known virtual assistant devices 9 include AMAZON ECHO, ALEXA, and GOOGLE ASSISTANT all of which may be pre-equipped with one or more speaker(s) and microphone(s) to enable the voice input communication and the voice output communication. The voice input communication and the voice output communication may include asking and receiving information ranging from the weather report to any encyclopedia question. Further, the operator 40 may personalize the voice input communication and the voice output communication via the virtual assistant device 9 to provide voices to be male, female, celebrity, and the like. The virtual assistant device 9 may include a cord and a suction cup 6 such that the virtual assistant device 9 can be fastened to the windshield of the vehicle 45.

The virtual assistant may be in communication with a navigational system (e.g., GARMIN technology) hosted in the vehicle 45 and/or with the electronic device 21. This way the electronic device 21 can remain in the smart safe body 1 while the operator 40 uses this technology for navigation. The operator 40 of the vehicle 45 can engage the engager-button 2 to provide voice input communication. The voice input communication may provide one or more services to the operator 40 such as but not limited to voice recorded messages processed on the virtual assistant to send to the desired recipient via the cellular-phone-service (e.g., notifying the desired recipient when the operator 40 is unable to respond due to driving and/or approximate times when the operator 40 will be free to respond based on communications received by the navigational system), purchasing of one or more items via the internet service, requesting a list of songs played on the radio, inputting personal information associated with the operator 40 to be stored on the electronic device 21, requesting specific responses based on the inputted personal information (i.e. bank account information), etc. The voice output communication may provide one or more services to the operator 40 such as reminders from the calendar on the electronic device 21, reminders for ongoing conversations on the electronic device 21, automatic updates for the electronic device 21, responses to the voice input communication, and the like. The virtual assistant may provide vehicle navigational services itself, or other vehicle utilities, preferably through compatibility through third-party applications, although the use of proprietary software is also contemplated. Examples of such vehicle navigational applications or vehicle utility applications intended to be compatible with the virtual assistant include any driving or navigational application provided by Apple® or Google®, such as Apple Maps®, Apple CarPlay®, or Google Maps®, MirrorLink®, Drivemode®, Cardo®, Android Auto®, navigational systems offered by Airbiquity® or Orderwerks®, JBL Smartbase® associated applications, Car dashdroid-Car infotainment®, CARFAX Car Care®, Cycle®, Driver®, Fully®, HONK Partn®, and any others.

In some embodiments, the smart safe console system includes a microphone configured to capture a voice of the user. Such voice capture may be used to interact with one or more of the features of the smart safe console system, through voice recognition software, or other means. In some embodiments, the smart safe console system assembly is configured to communicate with an audio system of the vehicle. Such communication with the audio system of the vehicle may be used for, amongst other functions, communicating alerts or other information to the user, or providing audio functions of the smart safe console system, such as music players, or hands-free call answering. In an exemplary embodiment, the assembly is configured to answer incoming phone calls, preferably through manual means such as pushing a button, more preferably through voice activated means, by using the microphone, and even more preferably by having the assembly automatically answer calls, and provide hands-free phone service by directing communication with the electronic device through the audio system and the microphone.

The transmitter 7 may be configured to communicate with a controller and a processor. The software application may be programmed to include a switch that enables communication between the transmitter 7 and the controller and the processor. The switch may be manually activated via interfacing with the software application or activated once the navigational system equipped on the vehicle 45 receives a signal that the desired destination (e.g., home) is less than a predetermined distance away. The controller and the processor may be communicably coupled to one or more features within the desired destination such that the one or more features can be turned on/off. The one or more features may include but not be limited to an alarm system, temperature settings, propane fireplace, lighting, sound system, such as a stereo, and powered kitchen accessories. Those with ordinary skill in the art will now appreciate that upon reading this specification and by their understanding the art of transmitters as described herein, methods of communication with powered objects via the transmitter 7 will be understood by those knowledgeable in such art.

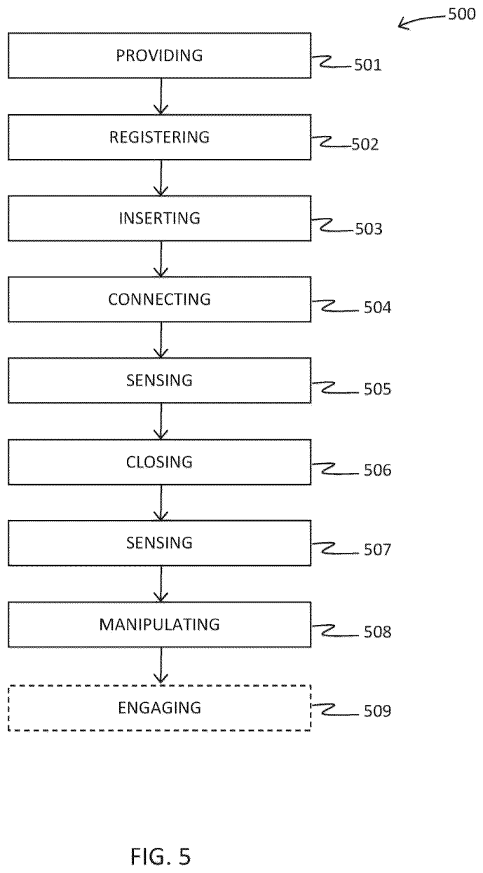

FIG. 5 is a flow diagram illustrating a method for using a smart safe console system 500, according to an embodiment of the present disclosure. In particular, the method for using the smart safe console system 500 may include one or more components or features of the smart safe console system 100 as described above. As illustrated, the method for using the smart safe console system 500 may include the steps of: step one 501, providing a smart safe console assembly 110 including a smart safe body 1 suitable to house at least one electronic device 21, an engager-button 2 configured for controlling input and output communications to and from the electronic device 21 when a vehicle 45 hosting the smart safe console system 100 is in use; the smart safe body 1 further includes a left-wing 13 and a right-wing 14 configured to move between an opened-state and a closed-state, and an interior-housing 4 defined by one or more walls, the left-wing 13, and the right-wing 14; the smart safe console assembly 110 may be in communication with a provider and with the vehicle 45 and may be configured to control use of the electronic device 21 in relation to manipulation of the vehicle 45; step two 502, registering the electronic device 21 with a software application in communication with the smart safe assembly 110; step three 503, inserting the electronic device 21 into the smart safe body 1; step four 504, connecting the electronic device 21 to a charging unit 17 equipped in the interior-housing 4; step five 505, sensing the electronic device 21 is connected to the charging unit 17 via at least one operation sensor and registered with the software application; step six 506, closing the left-wing 13 and the right-wing 14; step seven 507, sensing the left-wing 13 and the right-wing 14 are in the closed-state via the at least one operation sensor; step eight 508, manipulating the vehicle 45 (e.g., turning the vehicle 45 on); and step nine 509, engaging the engager-button 2 for controlling the input and the output communications to and from the electronic device 21.

It should be noted that step nine 509 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S. C. § 112(f). It should also be noted that, under appropriate circumstances, considering such issues as design preference, user preferences, marketing preferences, cost, structural requirements, available materials, technological advances, etc., other methods for using the smart safe console system 100 (NOTE: e.g., different step orders within above-mentioned list, elimination or addition of certain steps, including or excluding certain maintenance steps, etc.), are taught herein.

In some embodiments, the smart safe console system may be a before-market product for vehicles. In some embodiments, the smart safe console system may be an after-market product for vehicles. In many embodiments, the smart safe console system may be made with many different dimensions and/or shapes, or is adjustable in its dimensions and/or shapes, so as to properly fit many different shapes, sizes, and makes of various vehicles and the various middle consoles or center armrests that are in such vehicles.

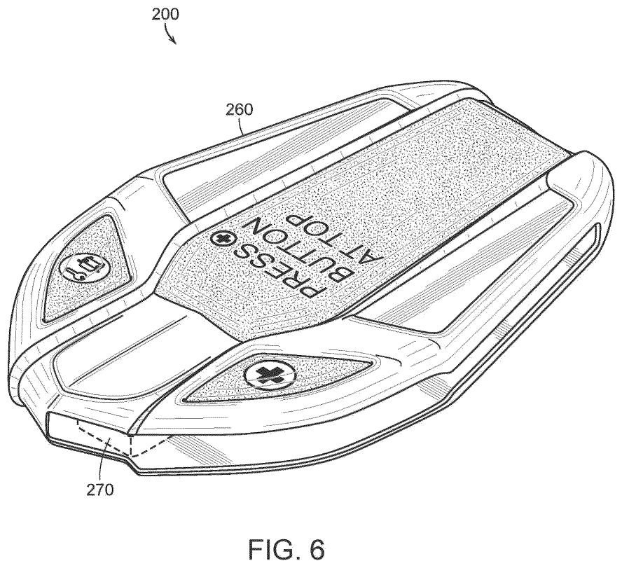

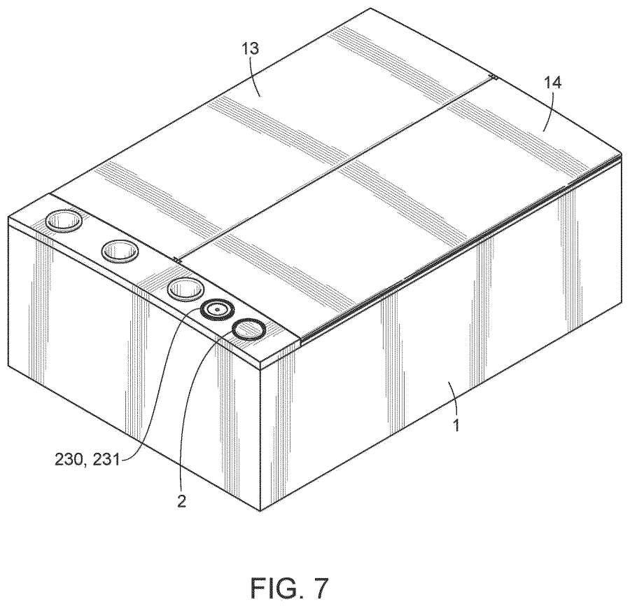

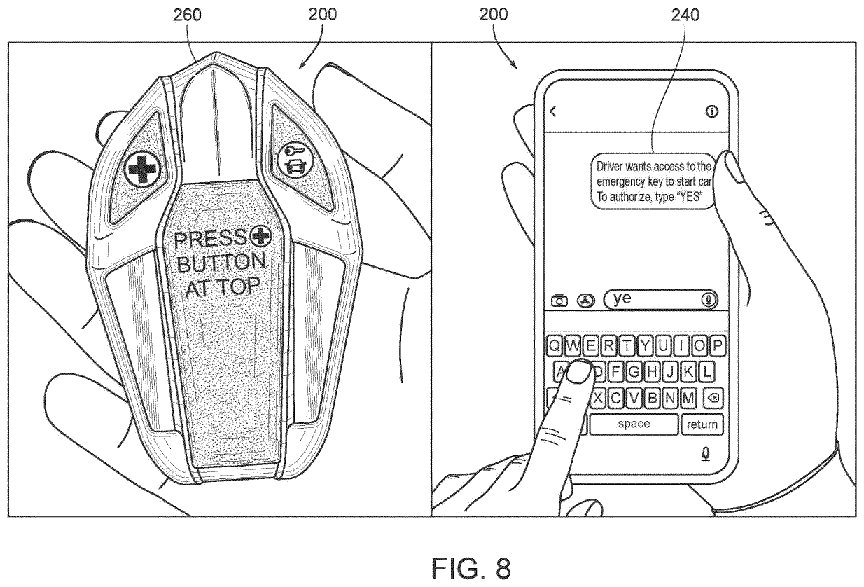

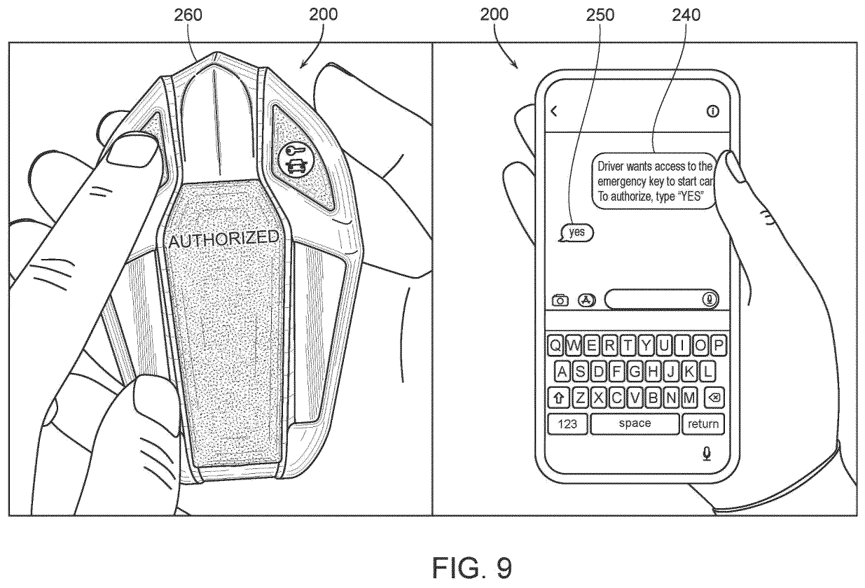

In some embodiments, with reference to FIG. 6-11 the smart safe console system 100 includes an override apparatus 200 configured to allow a user to override the control module and permit operation of the vehicle 45, preferably when the electronic device 21 is not secured within the safe body 1, or regardless of whether the electronic device 21 is secured within the safe body 1 or not. In some embodiments, the override apparatus 200 may be configured to require the user to enter information used to verify the user's identity before the override apparatus 200 will override the control module. In some embodiments, with reference to FIG. 8-9, the override apparatus 200 may be configured to include a function to notify an external user 250, such as an administrator, that override of the control module is requested, and will not override the control module until such request is granted by the external user 260. In some embodiments, the override apparatus 200 directly overrides the control module. In some embodiments, the override apparatus 200 may provide the user with a manual means of overriding the control module, such as a specialized key 270 or other type of tool or tools. In a preferable embodiment, the manual means of overriding the control module includes a specialized key 270, and the smart safe assembly 110 includes a keyhole 210 corresponding to the specialized key 270. In an exemplary embodiment, the keyhole 210 on the smart safe assembly is hidden behind an override button, the override button configured such that when depressed, opens to reveal the keyhole 210. In some embodiments, when the override button is depressed, the override apparatus 200 is engaged, and the keyhole 210 is only revealed once the override apparatus 200 verifies the user's identity. In some embodiments, the specialized key/override key 270 is contained in a compartment, and is only provided to the user once the override apparatus 200 verifies the user's identity. In some embodiments, further steps are required to enable either the override apparatus 200 to override the control module, or to reveal the override key 270, such as requiring the user to use a specialized tool 220, such as a screwdriver, to remove certain screws and/or caps 230 located on positions on the smart safe assembly 110 and/or inside the center console armrest. In some embodiments, the override apparatus 200 only overrides the control module once the override key 270 is inserted into the keyhole 210 and turned. In some embodiments, the smart safe console system 100 includes an emergency button, which when depressed for a predetermined amount of time will notify the authorities, such as the police, of the vehicle's location, preferably with a request for assistance.

In some embodiments, the override apparatus 200 may comprise a single device, or multiple devices linked together electronically, whether through wires or wirelessly. In some embodiments, with reference to FIG. 6, the override apparatus 200 comprises a handheld device 260 with buttons for ease of the user. In an embodiment, the handheld device 260 contains the override key 270, preferably within an interior compartment, and more preferably such that the key 270 is only revealed when the external user, such as the administrator, is notified 240 and grants a request to override the smart safe console system 250. In an embodiment, the key 270 is revealed by sliding, or otherwise displacing the key 270 out of the interior compartment, for example, such as through an unfolding hinge mechanism similar to a side-opening switchblade. In an embodiment, the handheld device 260 and/or override apparatus 200 may comprise an override notification system, for example comprising colored lights or sound systems that notify the user when the administrator or external user accepts the request to override the smart safe console system 100. For example, the colored lights may change in response to acceptance by the administrator of the request to override the smart safe console system 100 by changing from red to green or an integrated sound system may play a notification noise, such as chimes, ringing, beeping, songs, voices, or other sounds customizable by the user. Other methods of notifying the user that the request to override the smart safe console system 100 are also contemplated, such as vibration systems located in the override apparatus 200 and/or the handheld device 260. In an embodiment, the override key 270 may only be revealed upon further action by the user, such as by pressing an additional specified button on the handheld device 260, after the administrator or external user grants the request 250 to override the smart safe console system. In some embodiments, with reference to FIG. 8-9, the administrator may be notified 240 through the use of an app linked to the smart safe console system 100 and an electronic device 21 of the user. In some embodiments, the override apparatus 200 may comprise a digital screen and interface, such as a touchscreen, to allow the user to override the smart safe console system 100 using the override apparatus 200 alone. The digital screen and interface of the override apparatus 200 may also serve to notify the user that a request to override the smart safe console system has been granted 250 by an external user or administrator.

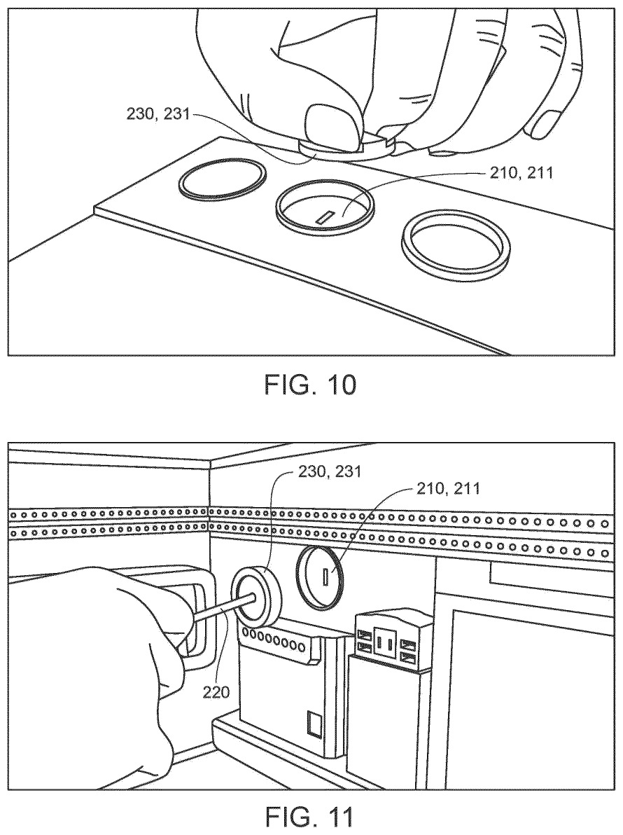

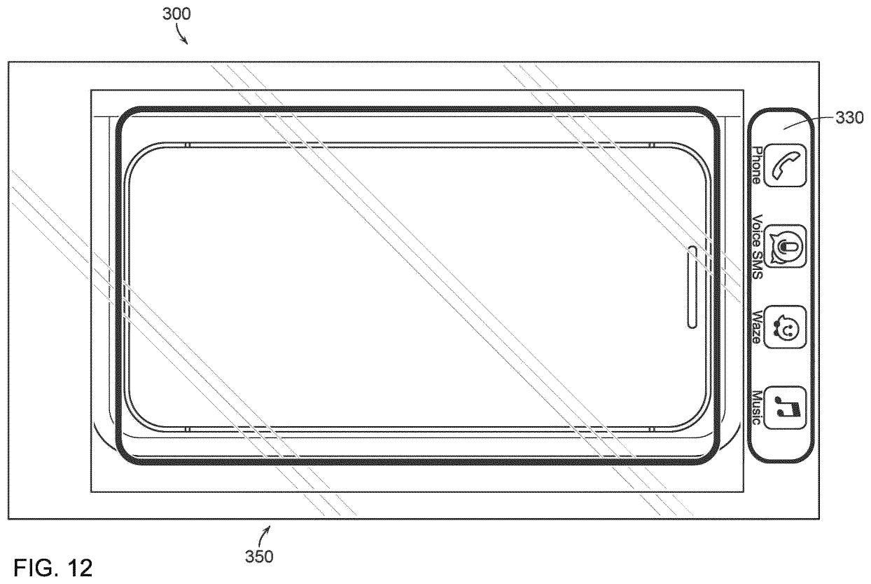

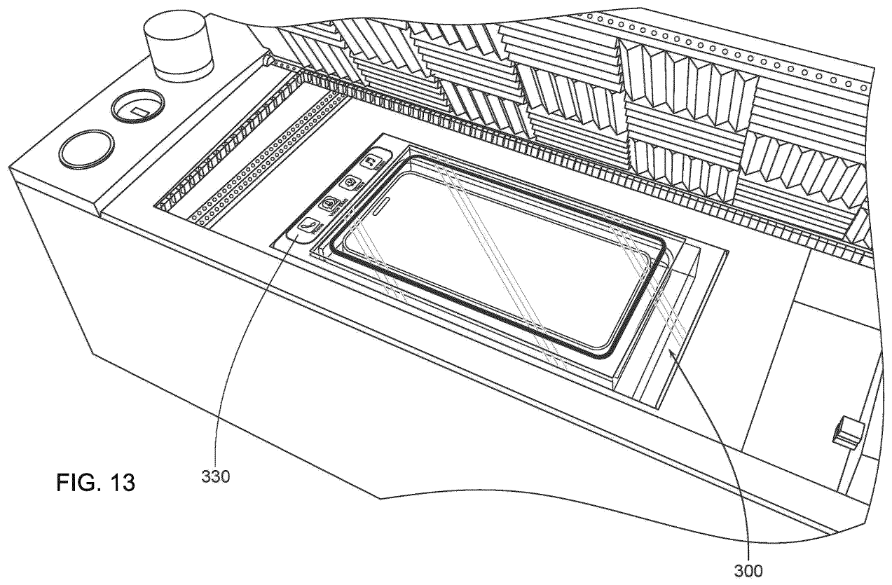

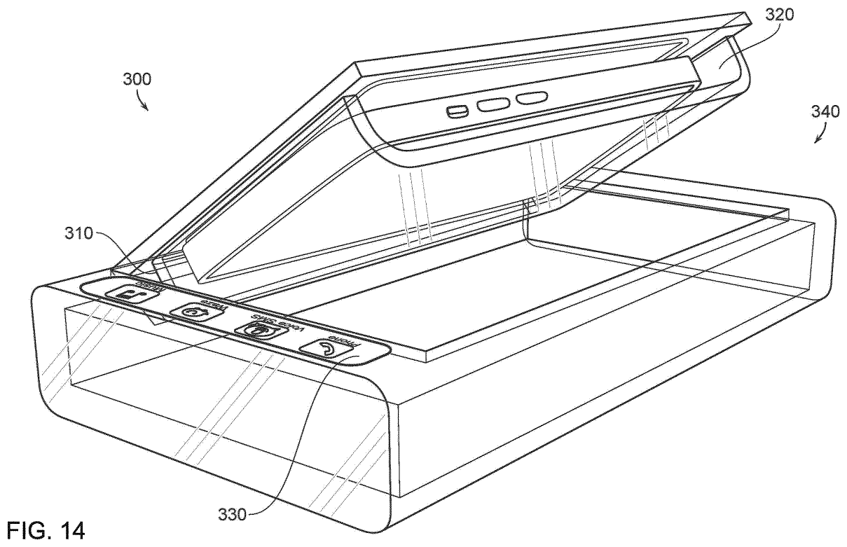

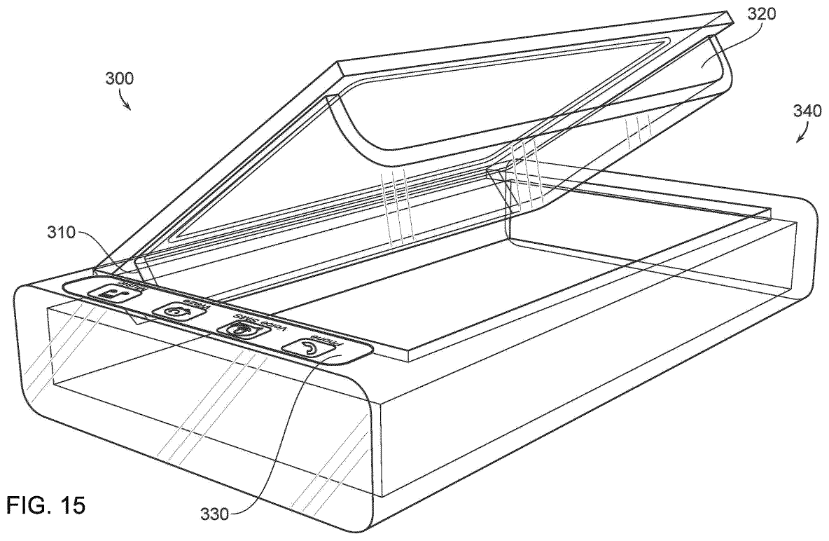

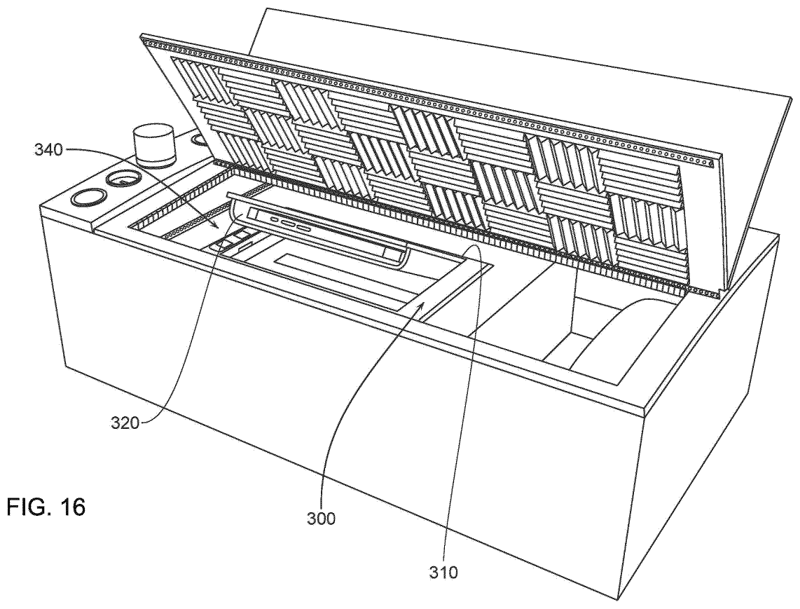

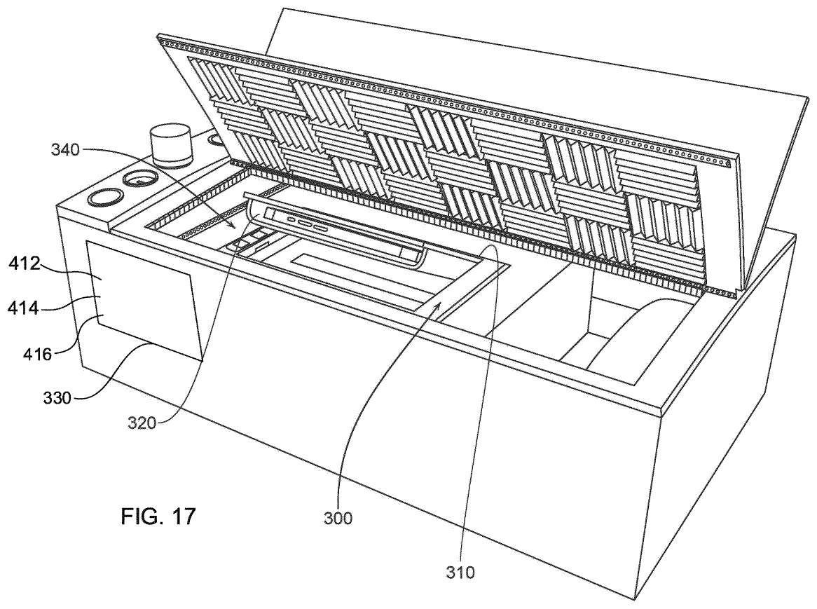

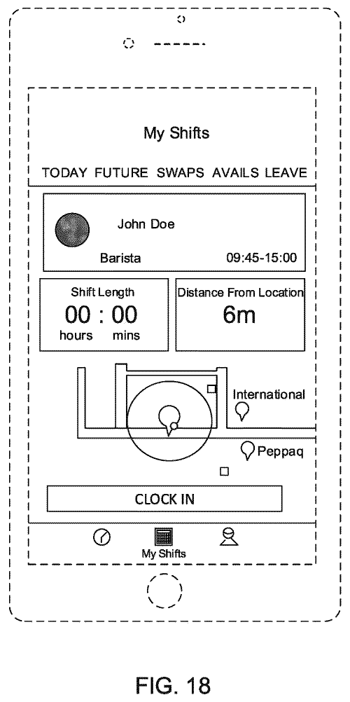

In some embodiments, with reference to FIG. 10-11, the keyhole 210 for the override key 270 includes multiple keyholes, preferably including at least a first keyhole 211, which when turned by inserting the override key 270, opens the safe body of the smart safe console system, and a second keyhole 212, which when turned by inserting the override key 270, allows override of the smart safe console system 100 and permits operation of the vehicle 45. In some embodiments, each of the one or more keyholes 210 is hidden behind caps or screws 230, such that a specialized tool 220 provided with the override apparatus, such as a hex key, Allen wrench, or screwdriver, is needed to remove the caps or screws 230 and reveal the one or more keyholes 210. In an exemplary embodiment, the user must remove a first cap 231 using the specialized tool 220, insert the override key 270 into a first keyhole 211 to open the safe body, then remove a second cap 232 using the specialized tool 220, and insert the override key 270 into a second keyhole 212 in order to override the smart safe console system 100 and operate the vehicle 45. Preferably, the first cap 231 and the first keyhole 211 may be located anywhere on the smart safe body 1, but the second cap 232 and the second keyhole 212 is located towards the front of the interior of the smart safe body 1. In an exemplary embodiment, once the user inserts the override key 270 into the second keyhole 212 and turns it, an additional notification is sent to the external user or administrator requesting override of the smart safe console system 100. In this exemplary embodiment, the vehicle 45 may only be operated and the smart safe console system 100 overridden once the external user or administrator grants this request. In an exemplary embodiment, the user must concurrently insert the override key 270 into the second keyhole 212, and turn it, preferably clockwise, while depressing a start button of the vehicle in order to override the smart safe console system 100 and begin operation of the vehicle 45 and/or start an engine of the vehicle. In some embodiments, the override key 270 may be turned in either direction once inserted into a keyhole 210.

In some embodiments, the override apparatus 200 and/or the handheld device 260 comprises an emergency notification button, which when activated, alerts emergency systems, such as the police, for example, by providing identification information about the user, information about the vehicle 45, and/or information about the location of the vehicle. In some embodiments, once the external user or administrator grants a request 250 to override the smart safe console system 100, the granted authority to override the smart safe console system 100 has a predetermined duration, such as for 24 hours, which may be customizable by the external user or administrator. After the duration for such granted authority has elapsed, the user must request authorization to override the smart safe console system 100 from the external user or administrator again before being able to override the smart safe console system 100 and operate the vehicle 45. In an embodiment, the override apparatus 200 and/or the handheld device 260 is waterproof and/or water resistant. In an embodiment, the override key 270 may also be capable of opening one or more of the vehicle 45 doors or trunk, but preferably may not be able to operate the vehicle 45 alone. In some embodiments, the override apparatus 200 comprises a case configured for containing one or more of the handheld device 260 and/or the specialized tool 220. In some embodiments, the override key 270, the override apparatus 200, and/or the handheld device 260 may comprise some functionality of a remote start system when used in conjunction with the smart safe console system 100 when using the override apparatus 200 to override the smart safe console system 100 and operate the vehicle 45 and/or start the engine of the vehicle 45. In an exemplary embodiment, the smart safe console system 100 and/or the override apparatus 200 comprises a cap 230, which when removed by the user using a specialized tool 220, reveals a keyhole 210 for use with the override key 270 in starting the engine of the vehicle 45 when the override key 270 is inserted into the keyhole 210 and turned, and a verification button of the override apparatus 200 and/or handheld device 260 is depressed.

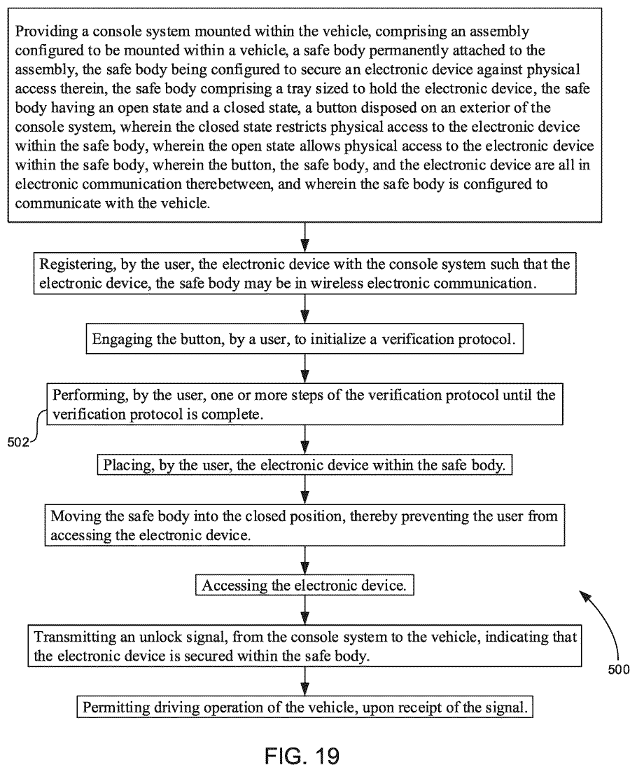

In some embodiments, the console system in accordance with the present disclosure can be configured to promote the safe operation of the vehicle in a variety of ways. In various embodiments, said console system can be configured to prevent impaired operation of the vehicle. In other embodiments, the console system in accordance with the present disclosure can be configured to prevent against theft of the vehicle or operation of the vehicle by an unauthorized user. Embodiments also exist where the console system in accordance with the present disclosure is used by on-the-clock workers to both clock their time operating the vehicle as well as to ensure these works do not utilize their electronic device while operating the vehicle. One embodiment of a method which promotes safe operation of the vehicle 500 is shown in FIG. 19.

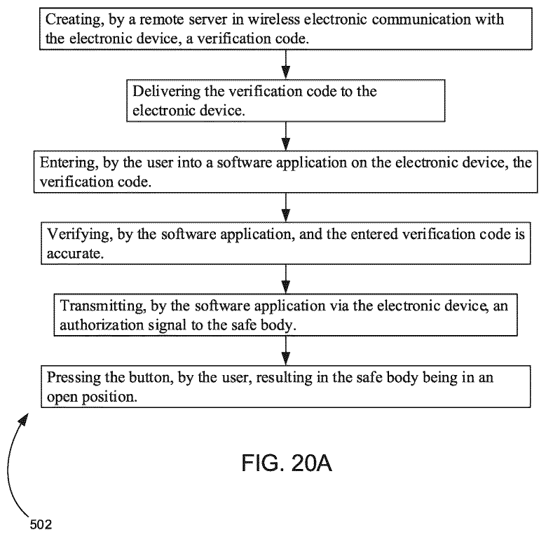

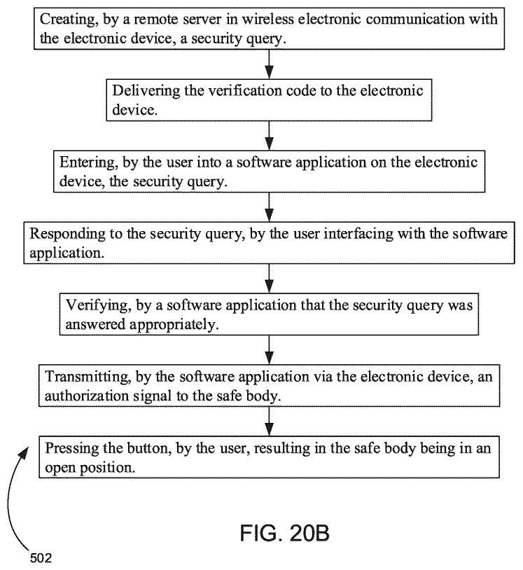

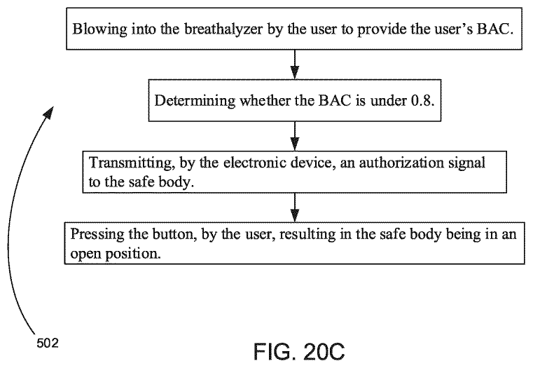

FIG. 20A shows an embodiment of the method in accordance with the present disclosure where the console system in accordance with the present disclosure is configured to prevent theft or other unauthorized use of the vehicle. There, a user can perform a verification protocol 502 as follows: First, a user presses a button disposed on the safe body. By pressing this button, a distinct code that will be sent to the user's email or phone number linked to a corresponding software application installed on the electronic device. The user then inputs this code into the software application, preferably within an “anti-theft” section of said software application. Once this step is completed and the authenticity of the entered code has been verified, the user can push the button again to move the safe body into an open position and place their electronic device therein. Once the electronic device is within the safe body, the safe body will be moved into the closed position upon which the console system will electronically communicate with the vehicle, permitting operation.

FIG. 20B shows an embodiment of the method in accordance with the present disclosure where the console system in accordance with the present disclosure is configured to prevent against impaired driving, which includes situations where the user is under the influence of alcohol, drugs, or is merely drowsy. Here, a user can be permitted to operate the vehicle by first pressing the button disposed on the exterior of the safe body. By pressing this button, initiation of a verification protocol on a corresponding software application on the electronic device will occur. Various verification protocols will be outlined below. In some embodiments, users will have 3 attempts to successfully complete the verification protocol. In other embodiments, users will have a single attempt.

Embodiments exist where the verification protocol comprises a puzzle where the user must rearrange digital puzzle pieces or other digital renderings of objects to a proper orientation. In other embodiments, the verification protocol is in the style of a CAPTCHA, whereby a user will be presented with partially obscured characters which must be entered into the software application. In other embodiments, the verification protocol consists of one or more questions which must be answered audibly. In some embodiments, the user will be presented with simple math questions, or will be tasked with listing a series of presented numbers in numerical order. In these embodiments, the software application will be equipped with a means for detecting slurred speech, preferably through the use of artificial intelligence trained on the user's voice. In some embodiments, the software application utilizes built-in voice assistants such as Siri or Alexa.

In other embodiments, users will gain operation of the vehicle by first pressing the button disposed on the exterior of the safe body which will generate a distinct code that will be sent to the user's email or phone number linked to a corresponding software application installed on the electronic device. Upon entering this code into the software application and the codes authenticity if verified, the user will then be presented with the verification protocol as outlined above. Upon completion of this verification protocol, the user will be permitted to place their device within the safe body which will be moved into an open position. Once the electronic device is placed within the safe body, the safe body is moved into the closed position and a signal is transmitted to the vehicle to permit operation.

In some embodiments, the console system in accordance with the present disclosure is equipped with a breathalyzer device. In these embodiments, an embodiment of the verification protocol 502 is shown in FIG. 20C. There, a user must blow into the breathalyzer as part of the verification protocol, and upon verifying that the user's BAC is below the legal limit within the user's jurisdiction, access to the interior of safe body will be permitted. In some embodiments, the console system in accordance with the present disclosure is equipped with a device which can detect the presence of marijuana odor. If detected, said console system will not permit operation of the vehicle. In some embodiments, users will be prompted to complete a Horizontal Gaze Nystagmus (HGN) Test as part of the verification protocol to ensure that the user is not unduly under the influence of alcohol or is experiencing meaningful drowsiness. In these embodiments, a camera feature on the electronic device will be utilized to perform this test. Preferably, a system utilizing artificial intelligence will analyze the user's eye movements to detect any signs of involuntary jerking, which can indicate impairment or drowsiness of the user. Embodiments exist where the image capture device used to perform the HGN Test is equipped with a night vision technology or similar technology to enable image capture in a low light environment.

Embodiments also exist where the console system in accordance with the present disclosure includes a punch clock system. In such embodiments, the user may press a button on the safe body to generate a code which will be sent to an email or phone number of the user. The user will then input this code into the designated login area for the punch clock on a software application on the electronic device. Preferably, this punch clock will determine the hours to be paid for driving. In order to start the vehicle, the user can press the button on the safe body console once more to prompt a “yes” input for syncing the electronic device with the console system. Only after completing this step can the user place the phone within the safe body to ultimately gain the ability to operate the vehicle. Embodiments exist where the punch clock contains a start time 412, an end time 414, and/or a timer 416 for use by the user to assist with time keeping.

In some embodiments, the user will be required to input an assigned ID number into the software application to ensure that the proper user is credited with the time spent driving. In other embodiments, the user will also have to input their assigned ID number into the software application when they are clocking out. In some embodiments, a digital interface is provided, via a software application installed on the electronic device, where the user may both clock in and clock out of a driving session. In these embodiments, users may also be provided with a shift scheduling interface whereby the user can see any upcoming shifts that they are scheduled for. Other embodiments exist where any overtime that a user may generate is tracked and logged by a software application installed on the electronic device and/or the console in accordance with the present disclosure. Embodiments also exist where any breaks that a user may take are tracked and logged by a software application installed on the electronic device and/or the console in accordance with the present disclosure. Additionally, other embodiments exist where users may request paid-time-off through said software application or may make other requests such as updating the user's personal information, view past pay stubs, or make other human resources-related requests. In some embodiments, said software integration can be configured to provide a user with direct payment for time spent, which can be paid using any standard payment mechanism. In yet other embodiments, said software application can generate one or more reports, showing the user and optionally a third party metrics on the user's interaction with said software application and the console in accordance with the present disclosure. In some embodiments, any upcoming shifts or breaks can be pushed to the user via a notification. Other embodiments exist where said software application integrates with a third-party payroll system.

Embodiments exist where the geolocation of a user is tracked by the console in accordance with the present disclosure and/or the electronic device.

In various embodiments, users of the console system containing a punch clock in accordance with the present disclosure must verify their identity. In some embodiments, a user will be prompted to log into a software application installed on the electronic device. In these embodiments, the user will have the option to log in using an email address, or a user-selected username. In some embodiments the user will provide a password while logging in, while in other embodiments, the user will be provided with a login code by a third party, such as the user's employer. In yet other embodiments, users will be prompted to log in using a PIN such as a 4-digit code. Embodiments exist where biometric data, such as a fingerprint or facial scan, are used to verify the identity of the user such that the proper user can be credited for the time spent driving. In the embodiments where a user is prompted to log in, two-factor authentication is an option that can be used.

In some embodiments, the software application on the electronic device will have a drowsiness section, wherein users are required to successfully complete a Psychomotor Vigilance Test (PVT) prior to starting the vehicle. The PVT is a widely employed tool for assessing an individual's attention and reaction time. In such embodiments, users are tasked with passing a reaction task where they must quickly respond to various visual stimuli, such as lights appearing on the screen. In other embodiments, users will be presented with numbers displayed within in a box, and the user must tap the screen once the numbers appear. Preferably, a system utilizing artificial intelligence will assess the alertness level of the user to determine if they are fit to drive the car.

Embodiments exist where the system in accordance with the present disclosure is equipped with one or more additional cameras. Preferably, these cameras will be integrated with an artificial intelligence system that is configured to detect whether a user is interacting with a second electronic device not secured within the safe body in accordance with the present disclosure. This will assist with preventing users from simply bringing two electronic devices with them and only securing one such device within the safe body in accordance with the present disclosure. In some embodiments, when a second electronic device is detected by these one or more additional cameras while the vehicle is in motion, a third party such as an employer, a fleet manager, or a parent, will have a message sent them to inform them of the presence of this second electronic device. Embodiments exist where a user may register this second electronic device with the system in accordance with the present disclosure to avoid these messages being sent to the third party. Preferably, within 10 minutes of beginning to operate the vehicle the user may pull over to register this second device.

In some embodiments, the system in accordance with the present disclosure is equipped with a “teenage mode.” That is, said system can be configured to have two use modes, one for adult users of the vehicle and one for younger users of the vehicle, such as teenagers. During operation of vehicles equipped with the system in accordance with the present disclosure, when in teenage mode, said system can restrict maximum speeds of the vehicle, and can place limits on the volume of audio emitted by the vehicle, including preventing the vehicle from omitting any audio whatsoever. Additionally, said system can provide alerts to a remote device via the Internet when the vehicle leaves a pre-set geofenced zone. Embodiments exist where the system in accordance with the present disclosure will monitor the driving behavior of the driver, including monitoring acceleration patterns and braking patterns. In some embodiments, the system in accordance with the present disclosure will also restrict operation of the vehicle outside of pre-approved operation hours. Embodiments also exist where the system in accordance with the present disclosure places restrictions on drivers making phone calls, even when their mobile device is secured within the safe body.

In some embodiments, the safe body in accordance with the present disclosure is located within a door of the vehicle. In other embodiments, said safe body is located in a center console of the vehicle. Embodiments also exist where said safe body is located in the glove box. Embodiments also exist where said safe body is located within the trunk of the frunk of the vehicle.

Embodiments exist where system in accordance with the present disclosure requires occupants of the vehicle to first buckle their seatbelts prior to vehicle disengaging the brake, even if the break pedal is pressed. Embodiments exist where the system in accordance with the present disclosure also provides a content filter for content on the radio.

Embodiments exist where after the vehicle is in use should the driver unbuckle their seatbelt, the system in accordance with the present disclosure will cause the vehicle to slow down and veer to the side. In some embodiments, the system in accordance with the present disclosure will restrict operation of the vehicle unless the driver places their mobile device within the safe body and moves the safe body into a closed position, and all occupants of the vehicle have fastened their seatbelt. In some embodiments, the driver must place all electronic devices within the safe body, including any wearables prior to the system in accordance with the present disclosure permitting operation of the vehicle. Embodiments of system in accordance with the present disclosure exist where the system also includes an oxygen source and oxygen pump. In such embodiments, when drowsiness of the driver is detected by the system, oxygen will be pumped into the cabin to assist with the driver's alertness.

For embodiments of system in accordance with the present disclosure which include a “teenage mode” the present disclosure also contemplates the registration of a super user who is able to bypass the safety restrictions of said system. In particular, this super user will be able to register an electronic device, such as a mobile phone or RFID transmitter which can wirelessly electronically interface with said system to provide this bypass. This super user will also be able to set a super user access pin such that the teenage driver cannot subsequently changes any of the settings without the super user's permission. In such embodiments, the system in accordance with the present disclosure can be configured to provide reports on the teenage driver's usage via the Internet. Additionally, said system can inform teenage drivers that if they use a second, unregistered mobile device while operating the vehicle they can be liable for any damages they cause. In some embodiments, the system in accordance with the present disclosure is equipped with an image capture device, and this image capture device can provide a live video feed of the teenage driver to the super user or other third party. Embodiments exist where the system in accordance with the present disclosure can utilize the image capture device to detect the presence of an unregistered mobile device being used by the driver. Upon detection, the system in accordance with the present disclosure will cause the vehicle to safely cease operation. Embodiments exist where said image capture device records a video feed during all times that the vehicle is in operation.

In accordance with one embodiment of the present invention, the SmartSafe system incorporates a multifunctional SmartSafe Tray designed to securely dock electronic devices, such as smartphones or other personal digital assistants, within a vehicle environment. The Smartsafe Tray is configured to provide both mechanical stability and operational integration with the vehicle's safety and communication ecosystem. The Smartsafe Tray is particularly advantageous in vehicles with limited dashboard or cockpit space, such as electric bicycles, scooters, and motorcycles, though it is equally applicable to four-wheeled passenger or commercial vehicles. The Smartsafe Tray is constructed from durable, lightweight materials, including high-strength polymers, carbon fiber composites, or metal alloys, which provide resistance to mechanical wear, vibration, and environmental exposure, thereby ensuring reliability over extended operational lifetimes.

In an embodiment, the tray is made out of a material that dampens sounds or shields electromagnetic radiation. The soundproof tray prevents the driver from hearing any noise emitted by the phone. In some embodiments, the tray may include at least one material with electromagnetic radiation shielding properties. Such electromagnetic shielding properties include, for example, the property of preventing wireless electronic communication with an electronic device placed within the smart safe body. In some embodiments, the electromagnetic shielding properties thus include shielding of one or more of any radio frequencies utilized by electronic devices to communicate, such as, but not limited to, frequency bands associated with the following technological standards: GSM, UMTS, LTE, 5G NR, and CDMA.

The interior surface of the SmartSafe tray may feature molded support material designed to secure the smartphone in place during charging and operation. The molded layer may be composed of foam, rubber, or neoprene, a synthetic rubber valued for its resilience, flexibility, and resistance to heat, water, and chemicals.

In some embodiments, the surface of the tray may include an interface screen. The interface screen may display icons for useful applications for use by the user. The interface screen is preferably touch-sensitive, although specialized buttons or other equivalent UI may be used.

In an embodiment of the present invention, the tray or the cassette player can be installed in various locations, including the front section of the center console, the driver's door, or the dashboard of a vehicle.

In an embodiment, the SmartSafe cassette unit is mountable within the instrument panel, typically positioned beneath the vehicle dashboard, thereby providing convenient and ergonomic access for the driver. The vehicle's infotainment screen may be positioned directly above or in front of the SmartSafe cassette player, allowing application icons such as navigation (e.g., Waze or HERE), music, phone, and system controls to appear on the façade of the cassette housing. Each icon is touch-activated, enabling seamless access without requiring driver attention diversion.

The Smartsafe Tray or cassette unit is configured with a push-push docking mechanism that allows the user to insert or remove a device using a single hand. In this mechanism, an initial push of the device into the tray (cassette unit) engages an internal locking mechanism that secures the device, while a subsequent push releases the device. This single-handed operation is particularly beneficial for riders of two-wheeled vehicles, where maintaining balance and operational control requires minimal distraction. The docking mechanism is configured to provide both tactile and haptic feedback, confirming successful engagement or release, thereby enhancing user confidence and reducing inadvertent misplacement of the device.

In an embodiment, the smart tray assembly provides conditional drive activation based on seatbelt and phone docking. The tray is configured to prevent the vehicle from shifting from the ‘Park’ gear to ‘Drive’ unless two conditions are simultaneously satisfied: (a) the driver's seatbelt is securely fastened, and (b) the driver's smartphone is docked within a designated docking station in the tray which can be located in center console, dashboard of the vehicle or armrest compartment. The docking station is configured to detect the presence of the smartphone in the tray, either through a wired (USB) or wireless (Qi or equivalent) charging interface. This embodiment ensures both driver presence and commitment to safe practices before allowing vehicle motion.

In another embodiment, the smart tray assembly provides dual key fob operation for role-based access. The smart tray assembly comprises a dual-key fob mechanism to differentiate between user types. A first key fob, referred to as the “Parent Key Fob” or “Fleet Manager Key Fob,” grants unrestricted access to the vehicle and disables safety restrictions, allowing the vehicle to start and shift using conventional methods such as an ignition button.

A second key fob, referred to as the “Teen Key Fob” or “Truck Driver Key Fob,” activates a restricted driving mode. In this mode, the vehicle will only start if the seatbelt is engaged and a smartphone is docked. Optionally, the system may require completion of a digital checklist displayed on the infotainment screen. The dual-fob system ensures driver-specific safety enforcement, which is particularly beneficial in teen driving and fleet management scenarios.

In another embodiment of the present invention, the smart tray assembly provides real-time driver behavior monitoring and parental notification. The tray is equipped with a real-time driver behavior monitoring module. The module captures and analyzes driving metrics such as vehicle speed, frequency of lane changes (especially those made without signaling), rapid acceleration or deceleration events, and the volume level of media playback. When any of these exceed pre-configured thresholds, the system automatically transmits alerts to designated parties, such as parents or fleet supervisors, via text message, email, or in-app notification. A “driver scorecard” may also be generated and made available to insurers or guardians to promote accountable and safer driving habits.

In another embodiment, the SmartSafe system is specifically tailored for fleet and commercial vehicle management. Under this configuration, a fleet manager may issue a registered company smartphone to a truck driver. The SmartSafe cassette player or tray is then synchronized with the unique phone number of the company-issued smartphone. Each time the driver attempts to start the vehicle, a verification code is automatically transmitted to the registered company phone. The driver must enter or confirm this code before the vehicle can be enabled. This ensures that only the authorized company-issued device can operate the vehicle, preventing unauthorized phones or drivers from starting the truck. Such a mechanism improves accountability and prevents circumvention of safety protocols through the use of unauthorized or personal devices.

In an embodiment of the present invention, the tray is provided with an Integrated Cooling Mechanism. The tray is equipped with a built-in cooling fan or thermoelectric cooling element designed to maintain optimal operating temperatures for docked devices. The cooling is especially useful in high-temperature environments or when the smartphone is docked for prolonged periods during navigation, streaming, or charging, thereby preventing device malfunction or overheating. The cooling fan is configured to use airflow from the vehicle's HVAC vent system. The cooling fan in the tray helps maintain a safe phone temperature and prevent overheating.

In an embodiment of the present invention, the smart tray assembly automatically activates the Infotainment system when a smartphone is docked inside the tray. Upon successful detection and connection of the smartphone, the tray may be configured to activate Apple CarPlay, Android Auto, or other in-vehicle infotainment platforms. This integration enables seamless access to navigation apps such as Google Maps or Waze, music playback, hands-free calling, and other permitted functionalities. The infotainment system may include a Bluetooth phone system set up so that the driver can ask for the name of a person to call and dial the number. The driver interacts with these features via the vehicle's touchscreen display, thereby eliminating the need to handle the phone directly while driving. The infotainment system or virtual assistant device is configured to allow the Teen Driver Mode to be set through a multi-step interface path: ‘Settings’→‘Vehicle’→‘Teen Driver’, where a guardian may configure and lock the settings using a four-digit PIN, optionally confirmed by double entry to prevent tampering.

In an embodiment of the present invention, the tray is provided with an AI-enabled anti-tampering and dummy phone detection mechanism. The tray is provided with an AI-powered camera mounted inside the vehicle, typically near the instrument cluster or rear-view mirror, or near the tray. The camera scans the driver's seat and the surrounding environment to detect the presence of unauthorized or dummy devices. If a phone is found outside the tray or if a non-functional decoy is used to bypass the docking requirement, the system alerts the fleet manager or guardian via secure communication channels. In some embodiments, the smart tray assembly may use RF sensors to detect a smartphone inside the vehicle cabin.

In another embodiment of the present invention, the cassette, tray, or docking compartment where the phone is stored may be constructed from tinted or opaque glass or plastic. The tinted glass is offered in various colors, such as blue, pink, green, yellow, black, or any other color. This structural feature obscures the smartphone's screen from the driver's view while docked, reducing the potential for distraction and encouraging focus on the road.

In some embodiments, the tray is configured to enable multi-user verification. The tray is configured to require two distinct smartphones to be inserted into separate slots of the tray or cassette holder before the vehicle can shift into drive. This is particularly applicable in ride-sharing, taxi, or instructor-student configurations, ensuring that both responsible users are present and accounted for. Each docking bay is independently monitored and may be assigned specific user profiles or roles.

In an embodiment, the system may incorporate a feature referred to as “Punch Clock,” primarily designed for fleet and commercial drivers. When the vehicle is in motion and the driver's smartphone is docked, the system records the operational duration. Based on pre-configured hourly wage settings, the system calculates compensation and processes payroll via the backend platform. This encourages compliance and creates a transparent accountability trail for both drivers and fleet operators.

In an embodiment of the present invention, the smart tray assembly is integrated with Advanced Driver Assistance System (ADAS) functionalities to enhance driving safety and situational awareness. The ADAS system gets activated automatically upon receiving any signal from the smartphone, either when it connects to the onboard system or when an incoming text message is detected. When an incoming text message is received, the driver will be forced to stay in the lane.

In an embodiment of the present invention, the ADAS module is embedded within or functionally connected to the tray structure and may include sensors, radar, LiDAR, or camera systems positioned near the tray, on the dashboard, within the vehicle cabin, or in the vehicle. These systems enable features such as forward collision warning, lane departure warning, blind spot detection, and driver drowsiness monitoring. In some embodiments, the ADAS module is activated only when the driver's smartphone is docked within the tray, ensuring authorized use and focused attention. The system may project real-time ADAS alerts, such as collision warnings or lane drift indicators, onto the windshield using Head-Up Display (HUD) technology integrated with the tray interface. In preferred implementations, the tray is configured to interface with on-board computing or an AI module located within the vehicle or smartphone to process sensor data and determine ADAS alerts. The tray may further include a tactile feedback mechanism, such as a vibration motor or warning buzzer, which activates in conjunction with visual HUD alerts to prompt corrective driver action. In certain embodiments, the tray is operatively connected to the steering system or infotainment interface to temporarily disable distracting applications or limit vehicle performance if ADAS alerts are ignored. This configuration ensures that the smart tray assembly not only secures digital devices but also acts as a central safety command node integrated with modern ADAS capabilities.

The Advanced Safety Assistance System (ASAS), also referred to as an Advanced Driver Assistance System (ADAS), is configured to activate upon receiving an incoming text message or phone call on the connected user device. Upon such an event, the ASAS module may automatically engage lane-keeping assistance, adaptive cruise control, or steering correction to maintain vehicle stability and prevent distraction-related incidents. This functionality ensures continuous lane maintenance for both passenger cars and heavy-duty vehicles such as trucks, even when the driver's attention is temporarily diverted by an incoming communication event.

In another embodiment of the present invention, the smart tray assembly or cassette player module is operatively connected to both the Head-Up Display (HUD) and the in-vehicle infotainment system, enabling synchronized visual presentation of critical information. In this configuration, navigation information initiated via a dedicated navigation button located on the tray or cassette player interface is displayed not only on the HUD for in-line-of-sight viewing but also on the infotainment screen for broader visibility and passenger reference. In an alternative embodiment, the smartphone screen is visualised on the infotainment system screen, and on the user presses the navigation button on the infotainment system, the screen is displayed on the windshield using Head-up-Display technology, and vice versa.

In an embodiment of the present invention, the SmartSafe cassette player is configured to project the HUD interface directly onto the windshield. In advanced embodiments, the system may also integrate with augmented-reality eyewear, such as augmented reality glasses, allowing the HUD elements to be displayed in the user's visual field through wearable optics.

Similarly, activation of a Bluetooth button on the tray or cassette player interface initiates wireless connectivity through the infotainment system, enabling hands-free calling and audio streaming without requiring manual access to the infotainment controls.

When the vehicle receives an incoming text message while the driver's smartphone is docked, the system is configured to display the sender's name on at least one of the HUD and the infotainment screen, or on both. The infotainment display further presents a visual indication that an automatic reply will be sent, instructing the sender to call instead of texting, thereby minimizing driver distraction. In a preferred implementation, the automatic replay additionally includes an estimated time of arrival (ETA) for the driver, calculated based on real-time navigation data. The ETA and auto-reply feature is functionally integrated with the tray or cassette player module such that it can be enabled, disabled, or customized through the tray's interface controls, ensuring seamless driver interaction without diverting attention from the road.

In an embodiment, navigation is simultaneously displayed on the infotainment system and the HUD display, even when the automatic reply is sent to the sender.

In yet another embodiment, the navigation or heads-up display (HUD) feature of the SmartSafe system is adapted to project route information not only on a vehicle windshield but also directly onto a rider's helmet visor or goggles. This configuration enables real-time display of navigation cues, warnings, or speed information within the rider's direct field of vision, improving safety by minimizing the need to look away from the road.

In another embodiment, the smart tray assembly integrates with home automation systems. When the driver docks the smartphone into the cassette tray player, the system communicates with connected home devices through a secure application interface. For example, upon docking, the system may automatically open a garage door, turn off interior or exterior lights, adjust thermostats, or activate other appliances linked to the user's smart home ecosystem. Preferably, such functionality is enabled through a subscription-based service offered by the original equipment manufacturer (OEM) or an authorized service provider, thereby providing continuous connectivity between the vehicle and home systems.

In some embodiments, the smart tray assembly provides fleet management and driver tracking functionalities. When a driver's smartphone is docked inside the cassette tray player, the system establishes communication with a backend monitoring platform, allowing fleet owners or supervisors to track vehicle usage in real time. The system may record data such as location, driving duration, and driver identity, thereby ensuring accountability, compliance, and safety in commercial or fleet driving scenarios.

In yet another embodiment of the present invention, the SmartSafe cassette player is configured to incorporate driver impairment detection features before enabling vehicle start or shifting into drive. In this embodiment, the system requires the driver to buckle the seatbelt (if the option is enabled in settings) and complete an AI-powered eye scan using the smartphone camera. The eye scan utilizes techniques similar to a Horizontal Gaze Nystagmus (HGN) test to detect potential intoxication. Only after successfully passing this check can the driver insert the smartphone into the cassette player on the wireless charging interface to enable driving.

In addition, the system may require the driver to complete a reaction-time test on the smartphone interface before the vehicle can start. The reaction-time test ensures that the driver is not impaired by drowsiness or other conditions that could hinder safe operation of the vehicle. The integration of these impairment detection protocols into the SmartSafe system enhances safety and provides an additional safeguard beyond conventional seatbelt-detection mechanisms.

In some embodiments, the SmartSafe console system further includes a color-adaptive ambient lighting feature configured to dynamically reflect the driver's driving style and mood. For instance, the lighting may turn red during aggressive or fast driving, and shift to a calming blue hue during relaxed, steady driving. The system continuously adapts the interior ambient lighting based on behavioral monitoring, thereby providing real-time feedback to the driver while also creating a more engaging driving environment.

In a further embodiment of the present invention, the SmartSafe console system is configured with a backup emergency start mechanism to account for situations in which the driver temporarily loses access to the registered smartphone that serves as the primary authorization device. The emergency start option is securely housed within the glove compartment or another restricted-access location of the vehicle.

In operation, activation of the emergency mechanism alone is insufficient to start the vehicle. Instead, the system requires a remote authorization step before enabling ignition. The nature of the remote authorization depends on the operational mode of the SmartSafe system. In Parent Mode, the request for emergency start is transmitted to a parent or legal guardian via the integrated parental control system. The parent or guardian may approve or deny the request in real time. In Fleet Mode, the authorization request is directed to the fleet manager via the fleet control interface, enabling oversight and secure decision-making before the vehicle can be started.

Upon receipt of valid authorization, the SmartSafe system provides a clear confirmation signal, such as illumination of a green indicator light on the key, to inform the driver that the emergency start has been approved and the vehicle may be operated. This design ensures that while drivers retain a last-resort option for emergency mobility, parental or managerial oversight remains intact, preventing unauthorized circumvention of the safety protocols embedded in the SmartSafe architecture.

In some versions, the SmartSafe cassette player for motorcycles and scooters is designed with enhanced environmental durability. The unit is IP 67 waterproof and weather-resistant, capable of operating across a wide temperature range (e.g., −4° F. to 158° F.). It further includes an anti-glare display for clear visibility under direct sunlight. For additional protection against rain and inclement weather, the unit may be fitted with a small cover or umbrella extending over the cassette player assembly.

In certain embodiments, the front façade of the cassette player itself incorporates a navigation display, allowing the rider to view route maps and turn-by-turn directions directly on the device screen. This front display provides redundancy to infotainment or HUD-based navigation and is particularly suited for two-wheeled vehicles. The SmartSafe cassette player is further configured to be securely mounted to the motorcycle or scooter's handlebar assembly, ensuring stability and rider accessibility during operation.

In another embodiment, the cassette player or tray body may be constructed using carbon fiber material. The use of carbon fiber offers lightweight strength, impact resistance, and durability, making the SmartSafe unit highly suitable for rugged environments and long-term usage in both automotive and two-wheeler applications.

In a further embodiment, the AI-powered camera integrated with the SmartSafe console is additionally configured to detect driver drowsiness and intoxication. The AI camera may be securely screwed or mounted to the vehicle frame and is programmed to analyze facial cues, eye movements, and head position to identify early signs of fatigue or impairment. Upon detecting such conditions, the system may issue visual, audible, or haptic alerts to the driver, and optionally transmit notifications to guardians, fleet managers, or authorized contacts. This feature enhances the overall safety functionality of the SmartSafe system by preventing operation under unsafe conditions. In another embodiment, the tray includes a push-push ejection mechanism similar to legacy cassette players. Once the smartphone is docked, a light press locks the device in place. To eject, the driver simply presses again to release it. This design enhances usability and tactile feedback while maintaining security when the vehicle is stationary.

To address vehicle security and prevent unauthorized operation, the Smartsafe Tray/cassette unit is integrated with an anti-theft authentication protocol. Upon insertion of a device into the tray/cassette unit, the system establishes a secure wireless communication link between the device and the control module. A time-sensitive authorization code is generated by the system and transmitted to the device, requiring successful confirmation before enabling vehicle start-up or control functions. This authentication ensures that only authorized devices, and by extension, authorized drivers can operate the vehicle, providing a robust theft deterrent and reinforcing identity verification mechanisms.

The Smartsafe Tray also provides integrated charging functionality, supporting both wired and wireless charging standards. When a compatible device is docked, the system initiates automatic power delivery to recharge the device without requiring separate cables or user intervention. This feature is particularly advantageous for devices used for navigation, telematics, or fleet communication, ensuring that the device remains operational throughout the trip. The charging interface is designed to accommodate various device sizes and form factors, including protective cases, and is equipped with thermal management features, such as heat-dissipating surfaces or passive airflow channels, to prevent overheating during extended charging periods.

For two-wheeled vehicles, such as electric scooters and e-bikes, the Smartsafe Tray system is ergonomically mounted to the handlebar or dashboard area in a position that allows the rider to view notifications, navigation prompts, or system status at a glance. The assembly may also include a front-facing display or LED indicators that convey critical information, including route guidance, battery status, or alert notifications, without requiring the rider to divert attention from the road. In addition, protective covers or anti-glare coatings are incorporated into the tray design to enhance visibility under bright sunlight or adverse weather conditions, while vibration-damping materials reduce the impact of road-induced shocks on the docked device.

The Smartsafe Tray further includes adaptive features for driver interaction, integrating tactile and haptic cues with the vehicle's human-machine interface. For instance, the tray/cassette unit may emit a subtle vibration upon successful device docking, charging initiation, or receipt of critical alerts from the SmartSafe system. These haptic cues enable eyes-free interaction, allowing the driver or rider to respond to system prompts without requiring visual confirmation. Additionally, the tray/cassette unit may be coupled with one or more multifunction buttons, providing seamless integration with voice-activated commands, route management, and safety alert systems.

In an additional embodiment, the Smartsafe Tray incorporates environmental protection features, including water resistance, dustproofing, and temperature tolerance, ensuring consistent device operation in diverse climatic and operational conditions. These features are particularly critical for two-wheeled vehicles, which are exposed to outdoor elements during regular operation. Moreover, the tray/cassette unit is modular and configurable, allowing installation across various vehicle types without requiring substantial modifications to existing dashboards, handlebars, or console surfaces.

The Smartsafe Tray of the present invention provides a multifunctional docking and security platform that combines mechanical stability, theft deterrence, integrated charging, ergonomic design, and multimodal feedback. Through this integrated approach, the Smart Tray enhances both vehicle security and driver convenience, while supporting the broader objectives of the SmartSafe system in promoting operational safety, device connectivity, and situational awareness across a wide range of vehicles, including two-wheelers, three-wheelers, passenger cars, and commercial trucks.

The Smart safe tray functions as the central operational and safety hub of the SmartSafe system, providing a comprehensive interface for vehicle control, driver authentication, behavior monitoring, and situational awareness. One of its primary functional aspects is driver authentication, which leverages biometric identification techniques such as eye-scanning or iris recognition to verify the identity of the operator. This functionality ensures that only authorized users can enable vehicle ignition or engage drive-ready states. Beyond authentication, the biometric module continuously monitors driver attentiveness, providing early detection of drowsiness, distraction, or impaired driving behavior. Upon detecting abnormal conditions, the console can initiate immediate intervention protocols, including visual, auditory, or haptic alerts, and temporarily restrict vehicle operation to prevent accidents.

The tray's event data recording functionality serves multiple operational purposes. Telemetry data, including speed, acceleration, braking patterns, steering input, lane departure events, route change, driver interactions, and system interactions, is continuously captured and logged. This data enables real-time safety monitoring, retrospective behavioral analysis, fleet management oversight, and insurance-based reporting. The EDR (Event Data Recorder) functionality is configurable to prioritize specific metrics based on the vehicle type, operational context, or user preference. For example, in commercial vehicles, cumulative driver behavior and route adherence may be emphasized, whereas in personal e-bikes or scooters, lane discipline and speed compliance are prioritized.

The Smart safe tray system also facilitates real-time driver communication and command execution through an integrated audio interface comprising speakers and microphones. Functional capabilities include voice-activated route acceptance, delivery of safety alerts, auditory feedback for system events, and direct interaction with fleet management systems. The Smart safe tray can interpret driver voice commands and update navigational instructions or system parameters without requiring manual intervention. These voice-based functions are complemented by the tray's programmable haptic touchscreen, which enables eyes-free interaction. Drivers can respond to prompts, confirm route changes, or adjust system settings using tactile feedback alone. The haptic interface is context-sensitive, providing unique vibration patterns for critical alerts, route confirmations, or system warnings, thereby reinforcing driver awareness while minimizing cognitive load.

In an embodiment of the present invention, the SmartSafe tray system is configured to emit both audible and visual alerts when a new route becomes available. The alert may consist of a flashing colored light, such as red, blue, or yellow, projected on the HUD, accompanied by an audible tone emitted from the internal speaker or the vehicle's infotainment system. The driver may respond verbally to accept or decline the route change.

In an embodiment of the present invention, the HUD employs a color-coded visual feedback system. A red light surrounding the interface indicates that the driver should request a new route, while a yellow illumination signifies a low-fuel condition and initiates automatic routing to the nearest refueling station. The alert colors can be user-configurable and synchronized with vehicle telematics data.

In addition, the Smart safe tray's multifunction buttons and configurable soft keys provide an alternative interaction layer. These buttons are dynamically adapted to vehicle mode, driver preference, or operational scenario. For example, a “Sync” button may initiate anti-theft verification procedures, while a “Voice” button triggers route acceptance or system inquiry prompts. This functional redundancy ensures that critical commands remain accessible under varying driving conditions.

The Smart safe tray also supports integration with mobile devices through a secure wireless charging holder. The wireless charging holder is functionally linked to authentication, navigation, and driver monitoring systems. When an electronic device is docked, it can serve as an input source, deliver supplemental alerts, or synchronize with fleet management platforms. The docking mechanism is engineered for ergonomic insertion, secure locking, and automatic recognition, preventing device removal during operation while maintaining seamless functional integration with the SmartSafe system.

Furthermore, the Smart safe tray incorporates environmental adaptation functionality. Anti-glare screens, waterproof casings, vibration-dampening mounts, and durable material construction allow reliable operation across diverse climates, terrains, and vehicle types. Real-time functional indicators, including LED status lights, audio prompts, and visual dashboards, ensure that the driver receives timely, context-relevant information without distraction.

The SmartSafe tray/cassette unit achieves comprehensive vehicle awareness and adaptive driver support through its seamless integration with the vehicle's internal control modules, including the Engine Control Module (ECM), Powertrain Control Module (PCM), Transmission Control Module (TCM), and Body Control Module (BCM). This integration allows the system to access a wide array of real-time data streams, enabling proactive safety interventions, contextual alerts, and operational optimization tailored to the driver, vehicle type, and driving environment.

The ECM integration provides continuous monitoring of engine performance parameters such as RPM, throttle position, coolant and engine temperature, and fuel injection efficiency. By analyzing these data points in real-time, the system can detect early signs of mechanical stress, overheating, or abnormal combustion patterns. Functionally, this allows the SmartSafe tray/cassette unit to generate proactive alerts, recommend operational adjustments, or temporarily limit vehicle performance to prevent engine damage. Additionally, the ECM data facilitates predictive fuel efficiency guidance, suggesting optimized routes or driving patterns to reduce consumption, particularly in commercial or long-haul scenarios.

The PCM integration enables centralized control over both engine and transmission systems. Torque output, load distribution, transmission mode states, and gear shift commands are continuously monitored and analyzed. Functionally, the SmartSafe tray can dynamically adapt driver assistance protocols based on powertrain conditions. For instance, under high-load scenarios such as uphill towing, the system may adjust ADAS sensitivity, modify HUD notifications, or suppress non-critical infotainment alerts to reduce cognitive load and improve vehicle handling. Torque anomalies or irregular powertrain behavior can also trigger immediate alerts to the driver or fleet management, enhancing predictive maintenance and operational safety.

The TCM integration focuses specifically on transmission operation, providing critical data on gear selection, shift timing, and engagement quality. SmartSafe tray leverages this information to prevent unsafe or unintended gear changes, particularly under conditions of driver distraction, fatigue, or impaired performance. Functionally, the system can momentarily suppress non-critical notifications, adjust HUD or HUD-adjacent alerts, and optimize gear shift assistance to maintain smooth and safe vehicle operation. In vehicles with manual or sport modes, TCM data informs adaptive thresholds for warnings, ensuring contextual safety across different driving styles.

The BCM integration provides comprehensive awareness of the vehicle's peripheral and auxiliary systems. Interior and exterior lighting, door locks, power windows, dashboard indicators, and overall vehicle startup/shutdown status are continuously monitored. SmartSafe tray utilizes this data to trigger context-sensitive alerts such as flashing lights or cabin illumination adjustments in conjunction with HUD notifications, auditory alerts, and haptic feedback. Functional applications include automatic locking of the wireless device holder upon vehicle shutdown, enforcement of cabin lighting cues during safety events, and coordination of visual and audio warnings in response to overspeeding or low-fuel conditions.

Collectively, the integration of ECM, PCM, TCM, and BCM provides holistic, context-aware vehicle intelligence. SmartSafe tray leverages these data streams to dynamically adapt safety, navigation, and driver assistance functions in real-time, effectively reducing false alerts, enhancing situational awareness, and optimizing operational efficiency. This integration also enables predictive intervention capabilities, including speed modulation, alert prioritization, and driver guidance based on combined powertrain, transmission, and peripheral system status. By centralizing control and intelligence from multiple vehicle modules, SmartSafe tray delivers an adaptable, scalable, and platform-independent safety solution applicable across passenger vehicles, two-wheelers, three-wheelers, and commercial fleets.

The SmartSafe tray incorporates a dynamic, event-driven mechanism for activating Advanced Driver Assistance Systems (ADAS) and Advanced Safety Assistance Systems (ASAS) based on detection of both external and internal stimuli that indicate potential driver distraction or impairment. Unlike conventional systems that rely solely on environmental factors such as proximity to obstacles, lane markers, or other vehicles, the SmartSafe tray continuously monitors communication events, driver behavior, and biometric inputs to identify situations where cognitive attention may be divided.

Externally, the SmartSafe tray monitors incoming communication signals from paired smartphones, vehicle telematics hubs, or fleet management dispatch platforms. For instance, when a new text message, call, route update, or destination change is detected, the system interprets these as potential distractions and automatically escalates ADAS/ASAS responses. Functionally, this may include activation of lane centering assist, adaptive cruise control, automatic following-distance regulation, or temporary suppression of non-critical infotainment functions. Simultaneously, the system modulates cabin outputs such as ambient lighting, infotainment screen brightness, and audio volume to redirect driver attention to essential operational tasks.

Internally, SmartSafe tray leverages biometric sensors, such as eye-tracking and gaze monitoring, combined with real-time vehicle telemetry from ECM, PCM, TCM, and BCM modules to detect fatigue, erratic steering behavior, or impaired driving patterns. When such indicators are detected, the system initiates internal stimulus-based safety protocols. These protocols may include temporary speed reduction, prioritization of HUD-based navigation cues, and lockdown of non-essential infotainment features. The system can also issue multimodal alerts through auditory, visual, and haptic channels to regain driver attention, ensuring that operational control remains within safe parameters.

For commercial and fleet vehicles, the SmartSafe tray supports remote configuration of ASAS activation thresholds based on communication events. Upon receipt of new assignments or instructions from fleet management, the vehicle may automatically enter an enhanced safety state. In this state, lane departure warnings, steering assist torque, and alert sensitivity are dynamically adjusted, while route change notifications are deferred to low-speed or stationary conditions to minimize distraction. Similarly, rideshare and delivery applications benefit from adaptive display and voice-prompt management, enabling passengers'requests or app notifications to be integrated without compromising driver focus.

The combined external and internal stimulus monitoring framework ensures that SmartSafe tray anticipates and mitigates driver distraction before it translates into unsafe vehicle operation. By linking cognitive load indicators, such as smartphone interaction, in-vehicle communication, and biometric attention metrics, with adaptive vehicle safety systems, the system provides proactive intervention, preserving both situational awareness and operational control. Through this holistic, anticipatory approach, SmartSafe not only improves individual driver safety but also enhances fleet-level operational reliability and compliance with safety regulations.

The SmartSafe tray incorporates an advanced Head-Up Display (HUD) configured to project real-time operational, navigational, and safety information directly within the driver's natural line of sight. In passenger vehicles and commercial trucks, the HUD projects onto the windshield or other transparent surfaces, allowing the driver to access critical information without diverting attention from the road. The HUD is integrated with the vehicle's Controller Area Network (CAN) bus and receives continuous data from the Engine Control Module (ECM), Powertrain Control Module (PCM), Transmission Control Module (TCM), and Body Control Module (BCM). This integration enables real-time display of vehicle telemetry, including speed, engine RPM, gear selection, throttle position, fuel levels, lane-keeping status, collision alerts, and warning indicators.

In addition to telemetry, the HUD presents dynamic navigational guidance, including turn-by-turn directions, distance to destination, estimated time of arrival, and route updates. The HUD operates in conjunction with voice-activated route acceptance, updating displayed directions immediately upon driver confirmation. Visual alerts are prioritized based on urgency, with critical warnings such as imminent collisions or overspeed conditions highlighted in prominent colors or flashing indicators, while informational messages are displayed in neutral or user-configurable formats. Adaptive brightness and contrast adjustments ensure optimal readability under varying ambient lighting conditions, reducing glare and minimizing distraction.

In embodiments for two-wheeled vehicles, including electric scooters and e-bikes, the HUD projects operational and navigational information directly onto the rider's helmet visor or shield. This configuration allows the rider to access real-time route guidance, speed, and safety alerts while maintaining full situational awareness and mobility.

The two-wheeler HUD receives telemetry data from the vehicle's onboard modules via the CAN bus, including speed, battery level, and motor performance metrics. The system presents contextual safety alerts, such as overspeed warnings, turn notifications, or obstacle proximity alerts, using color-coded or pulsing visual indicators. To complement visual feedback, the HUD can operate alongside auditory and haptic signals, such as voice prompts through a helmet speaker or subtle vibration feedback integrated within the SmartSafe tray or wearable modules, ensuring multimodal awareness without requiring manual or visual interaction.

For commercial vehicles and fleet operations, the HUD is configured to present multi-zone information suitable for co-drivers, dispatchers, or logistics operators. In this embodiment, the HUD displays operational metrics, driver performance indicators, route adherence status, and telematics-derived alerts alongside standard navigation and safety cues.

This embodiment allows fleet managers to monitor driver compliance, provide real-time rerouting instructions, and track fuel or performance efficiency without interfering with the primary driver's focus. Visual alerts on the HUD are coordinated with the SmartSafe tray's audio and haptic feedback mechanisms, ensuring high-priority notifications are promptly recognized. The system is adaptable to different vehicle sizes, from medium-duty trucks to long-haul freight vehicles, with scalable display areas and configurable information density depending on operational requirements.

In an embodiment, when the vehicle's fuel level falls below a preset threshold, the HUD display automatically flashes a red light around the navigation area to indicate low fuel. The system concurrently identifies and preloads navigation data for the nearest fuel station along the most efficient route. Upon the driver's voice command, such as ‘What is the address?’, the HUD presents the gas station location and navigation guidance.

For commercial vehicles and fleet operations, the HUD is configured to present multi-zone information suitable for co-drivers, dispatchers, or logistics operators. In this embodiment, the HUD displays operational metrics, driver performance indicators, route adherence status, and telematics-derived alerts alongside standard navigation and safety cues.

This embodiment allows fleet managers to monitor driver compliance, provide real-time rerouting instructions, and track fuel or performance efficiency without interfering with the primary driver's focus. Visual alerts on the HUD are coordinated with the SmartSafe tray's audio and haptic feedback mechanisms, ensuring high-priority notifications are promptly recognized. The system is adaptable to different vehicle sizes, from medium-duty trucks to long-haul freight vehicles, with scalable display areas and configurable information density depending on operational requirements.

The SmartSafe tray incorporates a programmable, quick haptic touchscreen interface configured to provide a highly intuitive, responsive, and safety-oriented human-machine interface for vehicle operation. This touchscreen interface is integrated into the SmartSafe tray or, in alternative embodiments, into the vehicle's infotainment unit, serving as a central tactile input method that allows drivers to access essential system functions while minimizing visual distraction and cognitive load. By providing a tactile and programmable input modality, the interface enables eyes-free operation for critical tasks, including navigation activation, route acceptance, voice command initiation, adjustment of safety or vehicle system settings, and interaction with multimodal alert systems.

The haptic touchscreen is engineered to generate precise tactile feedback in response to driver input. This feedback can include vibrations, pulses, or patterned sensations, allowing the driver to confirm selections through physical sensations rather than visual verification. The intensity, duration, and pattern of haptic feedback are fully programmable, permitting customization according to driver preference, situational requirements, ambient environmental conditions, or vehicle-specific operational contexts. For example, a short, subtle pulse may indicate successful menu selection, whereas a longer, patterned vibration can signal a critical alert or time-sensitive system notification requiring immediate attention.

In an embodiment, the haptic touchscreen incorporates a touch-sensitive haptic feedback that provides tactile confirmation to the user's finger during selection. This enables the driver to make adjustments or selections without diverting visual attention from the road.

Beyond simple confirmation, the haptic interface supports context-sensitive feedback, where the tactile response varies depending on the type of system interaction or alert. For instance, upon receiving a new navigation route or update, the interface may produce a distinctive vibration pattern prompting engagement with the voice acceptance feature. In situations involving safety alerts, system errors, or critical notifications, the feedback may be more pronounced or follow a temporally unique pattern to ensure rapid driver recognition without diverting visual focus from the road. Such context-aware responsiveness ensures the interface remains informative, non-intrusive, and adaptable across a variety of driving scenarios.

In an embodiment, when an alternate navigation route becomes available, the HUD emits a flashing visual cue, such as a red or other color-coded light, to prompt driver attention. The driver may issue a voice command, such as “Tell me the address”, upon which the system audibly announces the new destination. The driver may then verbally respond with ‘Yes’ or ‘No’ to confirm or decline the route change.

The design of the touchscreen interface takes into account ergonomic and operational considerations to ensure reliability and ease of use in varying lighting, environmental, and vehicular conditions. Sensitivity is carefully calibrated to distinguish intentional driver touches from accidental or incidental contact, reducing the likelihood of false activations that could distract the driver. The interface supports multi-touch recognition, gesture-based commands, and advanced input methods such as scrolling, swiping, or pinch-to-zoom, facilitating efficient interaction with dynamic navigation maps, vehicle telemetry dashboards, or multimedia applications.

Integration with the SmartSafe multimodal alert system allows the haptic touchscreen to complement visual and auditory notifications, reinforcing alerts across multiple sensory channels. For example, when a critical safety alert is displayed on the HUD or infotainment display, the touchscreen can generate a corresponding vibration pattern, enhancing situational awareness, improving reaction time, and minimizing the likelihood of missed notifications. This multimodal coordination is particularly beneficial in high-noise environments, low-visibility conditions, or complex urban driving scenarios.

The haptic touchscreen interface is further designed to adapt dynamically to the operational context. Feedback intensity and responsiveness may be automatically adjusted based on vehicle speed, driving environment, or user-defined preferences. During high-attention driving scenarios, non-critical feedback can be suppressed, while critical alerts are emphasized, ensuring the driver's focus remains on safety and essential operational decisions. In stationary or low-speed conditions, additional system information, diagnostic details, or infotainment options can be presented without compromising driver attention.

In commercial fleet, delivery, and rideshare applications, as well as two-wheeler implementations such as electric scooters or e-bikes, the haptic touchscreen interface provides a critical redundant pathway for driver interaction. This ensures essential functions can be executed safely even when visual and auditory attention is limited. The programmable and context-sensitive nature of the tactile feedback empowers drivers or riders to interact with system functions seamlessly, maintaining continuous situational awareness while reducing cognitive load.

Ergonomic placement and calibration of the haptic touchscreen facilitate ease of operation across diverse driver postures, lighting conditions, and vehicle configurations. The interface is positioned to support intuitive hand access from typical driving positions, while touch-sensitive zones are configured to provide consistent and reliable responses even under environmental constraints such as low light, glare, or inclement weather.

The haptic touchscreen operates in coordination with other SmartSafe control mechanisms, including multifunctional buttons, HUD prompts, voice-command inputs, and adaptive alerts, to provide redundant and complementary pathways for driver engagement. This integrated approach allows drivers to perform system functions, acknowledge alerts, and make operational adjustments safely and efficiently, enhancing overall vehicle safety and usability.

Collectively, the programmable quick haptic touchscreen interface provides an adaptive, context-aware, and ergonomically optimized human-machine interface. By combining programmable tactile feedback, context-sensitive responses, multimodal alert integration, and driver-focused ergonomic design, this interface enhances operational safety, reduces visual and cognitive distraction, and enables efficient, intuitive interaction with the SmartSafe system across multiple vehicle types and driving environments.

The SmartSafe tray incorporates a comprehensive multimodal sensory alert framework designed to deliver critical information to the driver through coordinated engagement of multiple sensory channels. The framework integrates auditory, visual, and tactile modalities to ensure that alerts are perceivable under diverse driving conditions, environmental contexts, and user preferences. By leveraging multiple complementary sensory pathways, the SmartSafe multimodal alert system enhances situational awareness, reduces response latency, and promotes safe driving behavior across a variety of vehicle platforms, including passenger cars, commercial trucks, two-wheelers such as scooters and e-bikes, and three-wheeled vehicles.

Auditory Alerts: Auditory notifications serve as a primary communication channel within the multimodal system. These alerts are delivered through internal speakers embedded within the SmartSafe tray, the vehicle infotainment unit, or dedicated onboard audio interfaces. Auditory feedback includes spoken prompts, such as context-sensitive instructions, navigation updates, incoming route changes, or safety advisories, as well as non-verbal signals including beeps, chimes, or patterned tones. The system is configured to vary the pitch, frequency, duration, and sequence of auditory signals based on the urgency or priority of the alert, allowing drivers to differentiate between routine notifications, cautionary messages, and critical warnings without requiring visual confirmation.

Visual Alerts: Visual cues complement the auditory channel by providing immediate, recognizable indicators of critical events. These cues are presented on the vehicle's Head-Up Display (HUD), the SmartSafe tray touchscreen, or other integrated dashboard indicators. Visual alerts may include flashing lights, color-coded symbols, animated icons, or graphical overlays to convey the type and severity of the notification. For example, red indicators may signify imminent hazards or urgent system warnings, whereas amber or blue may be used for informational or cautionary messages, such as fuel level reminders or speed limit advisories. Placement of visual alerts on the HUD ensures that critical information appears within the driver's natural line of sight, minimizing the need for eye movement and reducing cognitive distraction.

Tactile Alerts: Tactile feedback is provided through the programmable haptic touchscreen integrated within the SmartSafe tray or infotainment unit. Tactile signals deliver discrete, non-visual confirmation of alerts, system status updates, or driver interactions, enabling recognition without requiring the driver to look away from the road. The haptic output is programmable and context-sensitive, allowing distinct vibration patterns to correspond with different types of alerts, such as navigation prompts, route acceptance, incoming communication, or urgent safety notifications. The tactile modality is particularly advantageous in situations where auditory or visual cues may be impaired, such as high-noise environments, bright sunlight, inclement weather, or night driving conditions.

Coordinated Multimodal Operation: The multimodal alert system operates in a coordinated and synchronized manner, reinforcing the salience of critical notifications across all sensory channels. For instance, upon receipt of a new route assignment or detection of a safety-critical event, the system may simultaneously emit a voice prompt, flash a visual indicator on the HUD, and generate a corresponding haptic pattern through the touchscreen. This multi-channel reinforcement ensures rapid cognitive recognition, reduces response time, and minimizes the likelihood of missed alerts.

Context-Aware and Adaptive Functionality: The multimodal system supports context-adaptive alerting, dynamically modulating the intensity, frequency, and modality of notifications based on driving conditions, vehicle speed, environmental factors, and driver behavior. In high-speed or complex traffic scenarios, alerts are amplified across multiple channels to ensure prompt detection, whereas in low-speed or stationary conditions, notifications may be presented subtly yet remain perceivable. The system can also integrate with other SmartSafe functionalities, including biometric monitoring, driver fatigue detection, ADAS/ASAS interventions, and route management, allowing alerts to respond proactively to detected impairment, distraction, or operational hazards.

Redundancy and Safety Enhancement: By delivering critical information through multiple sensory channels, the SmartSafe multimodal system provides redundancy in alert communication, ensuring that the driver receives and responds to notifications even if one channel is compromised. For example, a critical safety alert may be detected via tactile haptics if auditory cues are masked by environmental noise, or via visual indicators if the driver is temporarily inattentive to auditory signals. This redundancy supports safe operation, minimizes missed alerts, and accommodates varying driver sensory preferences.

Integration with Driver Interaction Mechanisms: The multimodal alert system is closely integrated with other SmartSafe tray input and feedback mechanisms, including the programmable haptic touchscreen, HUD interface, and voice-command systems. This integration allows for cohesive, synchronized interactions where alerts can trigger multimodal confirmation feedback, and driver inputs can be acknowledged through combined auditory, visual, and tactile signals. For example, accepting a navigation route may produce a synchronized response across voice prompts, HUD confirmation, and haptic vibration.

Customizability and Scalability: The multimodal alert framework is configurable to suit different vehicle types, operational contexts, and user preferences. Visual display parameters such as color, brightness, intensity, and animation can be adjusted for optimal perception under varying ambient light conditions. Auditory cues can be modified in tone, volume, and speech content, while haptic feedback can be tailored in intensity, duration, and pattern. The system is scalable for application across diverse vehicles, including two-wheelers, passenger cars, commercial trucks, and rideshare vehicles, ensuring uniformity in safety-critical alert delivery while accommodating platform-specific constraints.

Collectively, the multimodal sensory alert category ensures that drivers are informed of critical vehicle status, safety warnings, navigational updates, and behavioral prompts through an integrated, redundant, and context-aware mechanism. By leveraging auditory, visual, and tactile feedback in a coordinated and adaptive manner, the SmartSafe multimodal system improves reaction time, enhances situational awareness, reduces cognitive load, and supports safe operation across a wide range of driving conditions, environmental contexts, and vehicle platforms.

The SmartSafe tray incorporates an advanced voice-activated interface designed to enable hands-free and eyes-free interaction between the driver and the vehicle's navigation, route management, and communication systems. This functionality allows drivers to receive, review, and respond to new route assignments, destination updates, or dispatch instructions without removing their hands from the steering controls or diverting attention from the road. The voice-activated interface is particularly advantageous for commercial drivers, rideshare operators, delivery personnel, and other professional users who require frequent route changes, dynamic destination modifications, or rapid operational feedback.

Upon receipt of a new route update, destination change, or dispatch message transmitted via integrated telematics, connected navigation platforms, or fleet management systems, the SmartSafe tray generates an audible prompt. This prompt, delivered through internal speakers embedded within the SmartSafe tray or vehicle infotainment unit, queries the driver regarding the received instruction, for example, “Do you accept or decline the new destination of [location]?” The prompt is designed to be concise, clear, and intelligible under varying acoustic conditions, ensuring effective communication even in high-noise environments.

The driver's verbal response is captured via an onboard microphone system, which may be tray-integrated or helmet-mounted in two-wheeled vehicle embodiments. Advanced voice recognition algorithms, optionally leveraging artificial intelligence-based natural language processing, interpret responses such as “yes,” “accept,” “no,” or “decline. ” The system supports multiple voice profiles, accents, and selectable personas, enabling personalized and reliable recognition across diverse drivers and operational contexts. In hybrid configurations, human operator assistance can supplement AI-driven recognition, allowing fleet managers or dispatchers to provide personalized guidance or context-specific instructions.

Upon verbal acceptance of a route update, the SmartSafe tray automatically updates the navigational data, presenting the revised route on the Head-Up Display (HUD) or infotainment screen, depending on user preference and vehicle configuration. The HUD display is strategically positioned within the driver's natural line of sight, typically slightly offset to the left of the central axis, to minimize eye movement and preserve situational awareness. Visual cues, such as route highlights, directional arrows, or destination markers, complement the voice confirmation, reinforcing the updated navigational context without requiring manual interaction.

In an embodiment, the HUD display is positioned slightly towards the left region of the driver's field of view to align with the natural gaze pattern, thereby further minimizing distraction.

In an embodiment, the HUD display includes color-coded indicators for driver status, wherein a red illumination corresponds to an overspeed condition and a blue indicator indicates compliance with speed limits. These color cues may be synchronized with the driver behavior monitoring interface for real-time feedback.

Multimodal feedback is integrated to ensure that the driver is aware of pending actions and that confirmations are acknowledged effectively. Upon receipt of a route prompt, the system may provide a short auditory tone, a flashing visual indicator on the HUD or tray display, and haptic feedback through the programmable touchscreen interface. This combination of auditory, visual, and tactile signals provides redundant confirmation of driver input, reduces ambiguity, and enhances confidence in the system's operation.

In scenarios where the driver declines a proposed route, the system maintains the current navigation parameters while optionally notifying fleet management, dispatch systems, or connected applications of the decision. All voice interactions, acceptances, declinations, and confirmations are logged to provide an audit trail for fleet analytics, operational review, and driver behavior monitoring. This logging capability ensures that decisions are recorded for performance evaluation, compliance monitoring, and operational analysis.

The HUD operates in conjunction with a voice-interactive AI module. When the HUD flashes a color-coded signal, such as red, the driver is prompted to ask ‘What is the new address?’ The system audibly responds with the destination and awaits a simple voice command, ‘Yes’ or ‘No’ to confirm or decline the new route. This interaction minimizes manual input and visual distraction.

The voice-activated system is context-aware and dynamically adaptive. During high-speed travel or complex maneuvers, non-critical prompts can be deferred or simplified, ensuring that essential navigation instructions are delivered without compromising driver attention or safety. Conversely, when the vehicle is stationary or moving at low speed, the full functionality, including detailed voice prompts, HUD visualizations, and haptic feedback, is available, providing comprehensive situational information and operational transparency.

The system is designed to integrate seamlessly with other SmartSafe tray functionalities, including the HUD, programmable haptic touchscreen, and multimodal sensory alerts, forming a coordinated human-machine interface. For example, a route acceptance may trigger a voice prompt simultaneously with a HUD indicator and a tactile confirmation pulse on the touchscreen, ensuring rapid recognition and minimizing the potential for missed or delayed responses.

The voice-activated route acceptance interface is configurable and scalable for various vehicle types and operational scenarios, including passenger cars, commercial trucks, two-wheelers such as e-bikes and scooters, and rideshare vehicles. Customization options include voice persona selection, language and accent preferences, prompt verbosity, and integration with fleet or dispatch management systems.

Overall, the Voice-Activated Route Acceptance and Interaction category provides a fully integrated, intelligent, and context-aware interface that allows drivers to safely manage dynamic navigational inputs through natural voice interaction. By eliminating the need for manual engagement with control panels or touchscreens, the system substantially reduces cognitive distraction, enhances situational awareness, improves compliance with routing instructions, and supports safe and efficient vehicle operation across a broad spectrum of driving environments and vehicle platforms.

The SmartSafe tray incorporates an advanced driver safety and intoxication mitigation module, engineered to enhance vehicle safety by continuously monitoring driver behavior and physiological indicators for signs of impairment, fatigue, or unsafe operation. This module integrates multiple sensing modalities, behavioral analytics algorithms, and real-time alerting mechanisms to provide a comprehensive preventive and corrective framework aimed at reducing accidents caused by drowsiness, intoxication, or inattentive driving. The system is applicable across diverse vehicle platforms, including passenger cars, commercial trucks, two-wheelers such as e-bikes and scooters, three-wheelers, and rideshare vehicles.

A central component of this category is motion-based driver behavior detection. Embedded sensors within the SmartSafe Console, dashboard, vehicle cabin, or wearable devices continuously monitor subtle driver movements, capturing hand, arm, head, and body motions, steering gestures, and pedal response patterns. Deviations from normal driving behavior, such as erratic hand movements, delayed reaction times, abnormal head motions, or inconsistent steering, are interpreted as potential indicators of impaired motor control, fatigue, or intoxication. Data collected from these sensors is processed in real time, enabling immediate identification of unsafe driving behavior before critical situations arise.

Complementing motion detection, the system employs biometric eye-scanning technology to provide both identity verification and attentiveness monitoring. The eye scan module, integrated into the SmartSafe tray, dashboard, or wearable interfaces, captures metrics including blink rate, prolonged eye closure, gaze stability, pupil response, and saccadic motion. This information is used to detect signs of drowsiness, inattentiveness, or intoxication. Biometric verification ensures that only authorized drivers can operate the vehicle, providing an additional layer of security while simultaneously enhancing continuous driver monitoring.

Upon detection of unsafe driving behavior or impairment, the SmartSafe tray initiates multimodal alerting to regain driver attention and encourage corrective action. Alerts may include: Visual warnings (Projected onto the Head-Up Display (HUD) or dashboard interface, using color-coded signals such as red flashes, prominent icons, or dynamic animations); Auditory prompts (Delivered through internal speakers, including spoken warnings, beeping tones, or patterned attention signals); Tactile feedback (Provided via the programmable touchscreen or steering interface, delivering vibrations, pulses, or haptic patterns corresponding to the severity of the detected behavior). The intensity, frequency, and modality of these alerts are dynamically calibrated to maximize effectiveness while avoiding startle responses that could exacerbate unsafe conditions.

In addition to alerting, the system incorporates configurable preventive intervention protocols to restrict vehicle operation under high-risk conditions. For example, when confirmed intoxication or severe drowsiness is detected, the system may: Temporarily inhibit vehicle start or ignition functions; Limit acceleration or engage adaptive speed control; Activate braking or lane-keeping assist functions; Lock non-essential infotainment or connectivity features to reduce cognitive load. These interventions are applied proportionally based on the detected level of impairment, ensuring that safety measures are contextually appropriate and effective.

The SmartSafe tray also logs driver responses, behaviors, and interventions for audit, operational monitoring, and compliance purposes. In fleet or commercial applications, real-time alerts and historical data can be transmitted to remote management or dispatch systems, enabling supervisory oversight and intervention when necessary. For personal vehicles, the system provides guidance such as recommending rest stops, modifying routes, or temporarily immobilizing the vehicle to promote responsible driving behavior.

Integration with telematics, insurance platforms, or parental/fleet monitoring systems allows for further extension of safety management. This integration enables external stakeholders to participate in proactive monitoring and intervention, enhancing safety outcomes, supporting regulatory compliance, and facilitating usage-based insurance (UBI) models.

By combining motion-based behavioral analytics, biometric verification, multimodal alerting, and operational restrictions, the Safety and Drunk Driving Considerations category delivers a proactive, comprehensive, and adaptive safety framework. This functionality is particularly critical for high-risk driver populations, including young operators of two-wheelers, novice drivers, and commercial fleet drivers. The system enhances situational awareness, reduces accident risks, and promotes secure, responsible vehicle operation across a wide variety of driving environments and transportation modalities.

The SmartSafe tray incorporates a highly flexible and adaptive AI/Human Operator Interface, engineered to provide continuous, real-time auditory communication between the driver and the vehicle's operational, navigational, and safety systems. This interface is designed to enhance driver situational awareness, reduce cognitive load, and promote safe, hands-free operation across a diverse range of vehicles, including passenger cars, commercial trucks, rideshare vehicles, e-bikes, scooters, three-wheelers, and fleet-managed units. At the core of the interface is an advanced Artificial Intelligence (AI) voice prompt generation framework, utilizing state-of-the-art text-to-speech (TTS) technology capable of producing natural, intelligible, and contextually nuanced spoken messages. These AI-generated prompts are synthesized in real time based on a wide variety of inputs, including route updates, incoming alerts, driver behavior notifications, telematics signals, operational directives, system status updates, and environmental conditions. The AI engine can dynamically adjust intonation, speech cadence, and emphasis to ensure that instructions are easily comprehensible, even in high-noise or high-stress driving environments, while minimizing distraction and maintaining driver focus on the roadway.

Complementing the AI-driven communication, the interface allows live human operator voice input, enabling fleet managers, dispatchers, or other authorized personnel to transmit personalized instructions, emergency alerts, or operational updates directly to the driver. This dual-mode configuration allows the system to balance automated intelligence with human judgment, particularly in complex operational scenarios such as fleet coordination, rideshare operations, dynamic routing, or emergency response situations. In such contexts, routine notifications, such as navigational updates or safety reminders, may be conveyed via AI-generated prompts, whereas critical, context-sensitive, or situation-specific instructions are delivered by a human operator. The system allows seamless switching between AI and human-generated prompts based on operational priority, ensuring that communication is always contextually relevant and effectively understood.

The interface is fully customizable, allowing drivers and fleet administrators to select preferred voice profiles, including male, female, or alternative synthesized personas. Volume, pitch, speech cadence, and other audio characteristics can be adjusted to suit driver preference, ambient conditions, or multi-lingual requirements, thereby enhancing clarity, comfort, and engagement. This customization supports multi-driver vehicles, fleet operations with diverse personnel, and environments where varying linguistic or auditory needs must be met. Furthermore, the system is capable of recognizing simple verbal confirmations or commands from the driver, such as “Yes,” “Accept,” or “Decline,” enabling hands-free confirmation of route changes, system prompts, safety acknowledgments, or operational commands. These voice-driven interactions are processed through advanced recognition algorithms and AI-based natural language understanding modules to accurately interpret commands, trigger system responses, and update navigation or operational modules in real time.

The AI/Human Operator Interface is integrated with other SmartSafe subsystems, including the Head-Up Display (HUD), programmable haptic touchscreen, and multimodal sensory alert framework. Upon receipt of a prompt, whether AI or human-generated, the system can simultaneously provide visual cues on the HUD, tactile feedback on the console or steering interface, and coordinated auditory alerts, ensuring that information is conveyed redundantly through multiple sensory channels. This multimodal feedback approach enhances prompt comprehension, mitigates the risk of missed notifications, and supports driver safety under diverse environmental or operational conditions. In addition, the interface supports contextual awareness, dynamically adjusting the priority, intensity, and modality of alerts depending on vehicle speed, traffic complexity, driver attention state, and operational urgency. For example, non-critical prompts may be deferred or minimized during high-speed or complex maneuvers, whereas critical safety instructions are immediately delivered across all sensory channels to ensure timely action.

In an embodiment, the SmartSafe cassette player connects and integrates directly with the vehicle's onboard software system, enabling AI-driven voice command control. The driver may adjust music volume, play FM/AM/satellite radio stations, and request navigation changes verbally. All results and prompts are displayed on the HUD, eliminating the need for a traditional infotainment display.

The system maintains a comprehensive chronological log of all AI-and human-generated communications, as well as driver responses. These records can be analyzed to monitor driver behavior, adherence to operational protocols, fleet performance, and compliance with safety regulations. Integration with telematics, insurance platforms, or fleet management systems allows real-time monitoring, intervention, or reporting, providing operational oversight and ensuring that drivers receive the guidance necessary to maintain safe and efficient vehicle operation. The AI/Human Operator Interface further supports hybrid operational modes, in which AI prompts are supplemented by human oversight to provide redundancy, flexibility, and resilience in environments demanding high reliability, dynamic decision-making, or rapid adaptation to changing conditions.

By combining AI-driven automation with human judgment, customizable voice profiles, real-time interaction capabilities, and coordinated multimodal feedback, the SmartSafe AI/Human Operator Interface provides a robust, adaptive, and context-aware communication platform. This interface ensures that drivers can safely manage navigation, respond to alerts, execute operational commands, and receive real-time updates without visual distraction or manual intervention. It represents a significant advancement in intelligent vehicle-human interaction systems, delivering a user-centric, resilient, and safety-enhancing auditory communication framework particularly suited for professional drivers, fleet operators, and shared mobility services, where timely, reliable, and clear communication is critical for safe and efficient operation.

The SmartSafe tray incorporates additional features designed to enhance driver convenience, operational efficiency, connectivity, and overall vehicle safety, extending beyond the core monitoring, alerting, and driver-assistance functionalities. These features are fully integrated within the SmartSafe tray ecosystem, ensuring seamless interaction with the vehicle, mobile devices, and remote management platforms, while remaining adaptable across a diverse range of vehicle types, including passenger cars, commercial trucks, rideshare vehicles, electric scooters, e-bikes, and three-wheelers. Collectively, these features serve to reinforce situational awareness, streamline operational tasks, and provide a user-centric experience that complements the system's primary safety mechanisms.

The SmartSafe tray is configured to provide the Post-Ride Audio Reminder, which is configured to activate automatically upon completion of a vehicle trip, vehicle shutdown, or ignition-off event. Leveraging data obtained from vehicle control modules and integrated sensors, the system determines when the trip has conclusively ended and triggers a clear, voice-based audio prompt through the internal speaker of the SmartSafe Console or infotainment unit. This reminder audibly instructs the driver to retrieve connected mobile devices, such as smartphones, tablets, or other docked electronics, from the integrated wireless charging holder or console docking slot. By providing this timely notification, the system mitigates the risk of device loss, ensures proper disconnection of paired devices, and promotes operational discipline and convenience, particularly in scenarios involving shared vehicles, fleet operations, or multi-driver usage.

The SmartSafe tray further incorporates Friends and Family Tracking, a GPS-based location-sharing functionality that allows drivers to securely share real-time vehicle location with pre-approved contacts, including family members, caregivers, or fleet supervisors. This feature is accessible via a dedicated mobile application or the vehicle interface and operates under encrypted protocols to ensure privacy, limiting access exclusively to authorized recipients. The tracking functionality provides valuable safety and monitoring benefits, enabling authorized parties to monitor trip progress, verify route adherence, or coordinate fleet operations in commercial contexts. In personal applications, it facilitates reassurance for guardians of young or novice drivers, long-distance travelers, and rideshare passengers, enhancing both safety and operational transparency.

Additionally, the SmartSafe tray features a Programmable Haptic Touchscreen interface, which serves as an auxiliary input and feedback mechanism designed to support eyes-free interaction. The haptic touchscreen generates precise, context-sensitive tactile feedback in response to driver inputs, including navigation selection, voice-command activation, route confirmation, or system control adjustments. Feedback parameters such as vibration intensity, pulse duration, and feedback patterns are fully customizable, allowing adaptation to driver preference, operational environment, ambient conditions, or specific task requirements. This tactile interface reduces cognitive load, minimizes distraction, and enables safe, hands-free operation under low-light conditions, inclement weather, high-traffic scenarios, or complex navigational contexts.

The additional features of the SmartSafe system are designed to operate in a context-aware manner, dynamically adapting functionality based on vehicle status, operational conditions, and user preferences. For instance, the post-ride audio reminder is only activated after confirmed trip completion, friends and family location sharing may suspend transmission while the vehicle is in motion to prevent distraction or privacy concerns, and haptic feedback intensity or patterning may adjust automatically based on vehicle speed, navigation complexity, or environmental factors. These adaptive measures ensure that supplemental functionalities enhance driver convenience and operational support without interfering with vehicle safety or situational awareness.

By integrating post-ride reminders, real-time location tracking, customizable haptic interfaces, and context-sensitive operational adaptations, the SmartSafe system provides a comprehensive and modular platform that enhances driver engagement, connectivity, and overall safety. These features collectively complement the core monitoring, alerting, and assistance functions of SmartSafe, offering a seamless, user-focused experience that promotes operational efficiency, responsible device management, and proactive safety practices across a wide range of vehicle types and mobility scenarios. The modular and scalable design of these additional features ensures compatibility with both personal and commercial vehicles, extending the effectiveness and versatility of the SmartSafe system in diverse real-world applications.

In an embodiment of the present invention, the SmartSafe tray comprises a voice-activated destination acceptance system, which allows drivers to receive, review, and confirm or decline route changes, navigation updates, or fleet dispatch instructions entirely through voice commands. This feature reduces manual distractions while maintaining operational efficiency, particularly for commercial vehicles and rideshare operators. Multimodal prompts, including audible feedback, visual cues on the HUD, and haptic notifications, provide redundancy and improve driver compliance and awareness.

The system further incorporates a multimodal sensory alert framework, which combines HUD notifications, dashboard and interior lighting, auditory beeps, and haptic touchscreen feedback to ensure that critical information is communicated effectively to the driver. This approach enhances situational awareness and allows the driver to respond promptly to safety events or operational prompts without compromising attention to the road.

In an embodiment of the present invention, the smart safe system is compatible with HERE navigation technology, which is widely adopted by truck and rideshare drivers such as Uber operators. The SmartSafe system can directly interface with HERE's real-time mapping and traffic APIs to provide updated route guidance through the HUD or in-vehicle display.

Embodiments for helmet-based HUD projection are also enabled, wherein navigation and system information are directly displayed on a rider's helmet visor, facilitating situational awareness for operators of two-wheeled vehicles such as e-bikes and scooters. This feature extends the safety benefits of SmartSafe to vehicles beyond traditional automobiles.

The system includes an integrated speaker and microphone interface to support bidirectional voice communication for route guidance, voice-command interactions, and driver response capture. This interface enables hands-free operation and seamless integration of AI-driven or human operator prompts, providing an adaptable and reliable auditory communication channel.

The scalable architecture of SmartSafe tray allows for operation across a diverse set of vehicles, including e-bikes, scooters, cars, three-wheelers, and commercial trucks. The system dynamically adjusts its feature set, hardware footprint, and integration depth based on vehicle type and operational requirements, ensuring a consistent user experience while optimizing resource utilization.

The system leverages internal modules and sensor networks to continuously track and assess driver behavior, detecting unsafe conditions, impairment, or distraction. Timely alerts, control interventions, and historical logging of driver behavior enable both immediate safety improvements and long-term monitoring for training, fleet management, or insurance purposes.

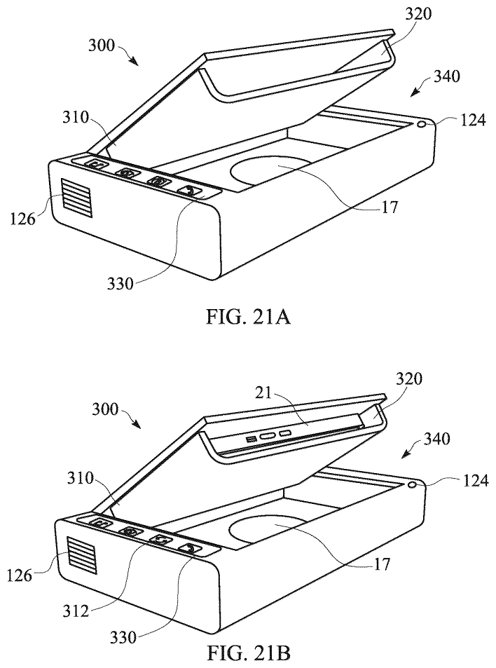

FIGS. 21A and 21B illustrate perspective views of a smart tray assembly 300 forming part of a smart safe console system, according to exemplary embodiments of the present invention. The tray assembly 300 is shown in an open state 340, depicting the configuration in which an electronic device, such as a smartphone, may be inserted or removed.

As illustrated, the smart tray assembly 300 is configured to securely receive, retain, and electronically interface with a portable electronic device such as a smartphone, tablet, or similar communication device. The tray assembly 300 may be structurally integrated within various vehicle regions, including, but not limited to, the center console, dashboard, or armrest compartment, depending on vehicle design preferences and space constraints.

The tray assembly 300 includes a main body housing having an upper surface in which a slot 320 is formed. The slot 320 defines an insertion opening leading to an interior compartment adapted to receive and securely hold the electronic device during operation or while the vehicle is in motion. The compartment may include resilient or cushioned liners to prevent vibration-induced damage or displacement of the device.

Within the interior compartment is positioned a charging unit 17 configured to deliver inductive power to the docked electronic device. The charging unit 17 may operate in accordance with Qi, PMA, or other recognized inductive or resonant charging standards, and may also incorporate power monitoring and data communication capabilities. These features enable the tray assembly 300 to establish a bidirectional data link with the docked smartphone for synchronized operation, behavioral tracking, or vehicle system integration.

A spring mount 310 mechanically couples a hinged lid structure to the main tray body, permitting controlled vertical or angular displacement. The spring mount 310 may implement a push-push ejection mechanism, allowing the tray lid to alternate between the open and closed positions in response to a light manual press by the user. In some embodiments, damping elements may be included to ensure smooth, noise-free motion during lid actuation.

Disposed on the upper surface of the tray body is an interface screen 330, which may comprise a capacitive touchscreen or a hybrid display panel incorporating discrete touch-sensitive buttons. The interface screen 330 provides both visual and tactile interaction with the user, displaying status indicators, icons, and control menus for operations such as navigation, media access, Bluetooth synchronization, or behavioral monitoring. The embedded touch buttons may include dedicated navigation, music, sync, and Bluetooth controls. In certain embodiments, the interface screen 330 dynamically presents the operational status of the tray, such as locked/unlocked, device detected, or charging active, to provide real-time user feedback.

An indicator light 124 is mounted on a side face of the tray assembly 300 to convey visual status cues. The indicator light 124 may illuminate in multiple colors, such as green, red, or amber, to signify respective states, including successful phone docking, charging progress, fault conditions, or activation of safety-related modes linked to the smart console system.

A cooling fan 126 is integrated within the tray body and oriented to exhaust air through discrete vents for active thermal management. The fan 126 maintains a stable internal temperature during high-power tasks such as video streaming, navigation, or extended data synchronization, thereby preventing the smartphone or electronic components from overheating. In some embodiments, the fan operation may be automatically triggered by onboard temperature sensors or charging current thresholds.

In one embodiment, the tray assembly 300 is fabricated from sound-dampening and/or electromagnetic-shielding materials. The soundproof structure reduces audible noise emitted by the smartphone, while the EM-shielding layer prevents interference from, or leakage of, radiofrequency signals, thereby preserving the vehicle's electronic stability and data privacy integrity.

In an embodiment of the present invention, the smart safe cassette player may have an oval-shaped profile, incorporating three control buttons on each lateral side, and a central rotary knob for adjusting audio volume. A dedicated button may also be provided to activate the voice assistant for hands-free commands.

As shown in FIG. 21B, an electronic device 21 is depicted docked within the tray via the slot 320, illustrating its secure placement and alignment with the charging unit 17 for inductive power transfer. The precise fit ensures stable connectivity and vibration isolation even during vehicle movement.

Both FIGS. 21A and 21B depict the tray assembly 300 in the open state 340, with the slot 320 fully accessible for device insertion or removal. In a corresponding closed state (not shown), the slot 320 may be sealed by the lid structure, and access can be electronically restricted through locking mechanisms, biometric authentication, or software-based interface permissions, thereby enhancing the security and privacy of the docked device.

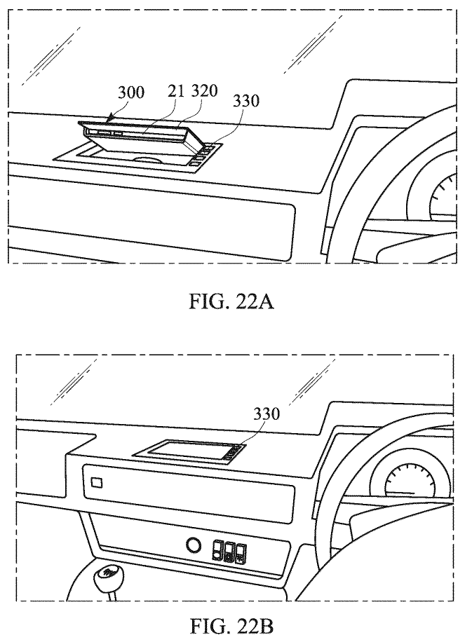

FIGS. 22A and 22B illustrate perspective views of a smart tray assembly 300 integrated within the dashboard region of a vehicle, shown respectively in an open state and a closed state, in accordance with exemplary embodiments of the present invention. The illustrated embodiment demonstrates the structural adaptation of the smart tray assembly 300 for in-dash installation, highlighting its ergonomic placement and functional connectivity within the vehicle cabin.

Referring to FIG. 22A, the smart tray assembly 300 is mounted in a recessed cavity formed in the vehicle's dashboard structure, located within comfortable reach of the driver while being oriented at an angle that minimizes distraction from the road. In the open state, the slot 320 of the tray is exposed, allowing insertion or removal of an electronic device such as an electronic device 21. Upon insertion, the electronic device 21 aligns with and rests against a wireless charging interface positioned within the interior compartment of the tray (not visible in this view). Through this interface, the smartphone becomes electrically and operatively coupled to the smart tray assembly 300, enabling power transfer, communication, and data synchronization with vehicle systems.

An interface screen 330 is prominently visible adjacent to or slightly above the tray opening. The interface screen 330 serves as a control and status interface for the tray assembly 300 and related vehicle systems. The user may utilize the interface to initiate or configure operational modes such as phone docking confirmation, infotainment access, driver behavioral monitoring, or integration with Advanced Driver Assistance Systems (ADAS). In some embodiments, the interface screen 330 further displays contextual indicators, including charging progress, lock/unlock status, and active user profile modes (for example, Teen Driver Mode, Fleet Mode, or Administrator Mode). The interface screen may also support touch-based or haptic input, allowing the driver to interact with the tray assembly even while the device is enclosed.

Referring now to FIG. 22B, the tray assembly 300 is shown in its closed state, in which the slot 320 is sealed and no longer accessible. In this configuration, the electronic device 21 remains securely enclosed within the tray compartment, protected from physical tampering or driver distraction. The interface screen 330 remains externally visible and functional, continuing to display system status, notifications, or restricted user controls. Even in the closed state, the tray assembly maintains full operational capability, including wireless charging, infotainment data synchronization, vehicle telematics logging, and hands-free communication support. The closed configuration thus ensures device security while maintaining seamless connectivity with the vehicle's onboard systems.

As seen in both figures, the dashboard-integrated tray configuration embodies an ergonomically optimized and aesthetically cohesive design that complements the vehicle interior while supporting intuitive driver engagement. The mechanism for transitioning between the open and closed states may be implemented as a manual push-push actuator utilizing the spring mount 310, as previously described, or through an electronic motorized drive controlled via the interface screen or a linked command input. Optional soft-close mechanisms, LED illumination, or sensor-based actuation may be employed to enhance user experience and operational safety.

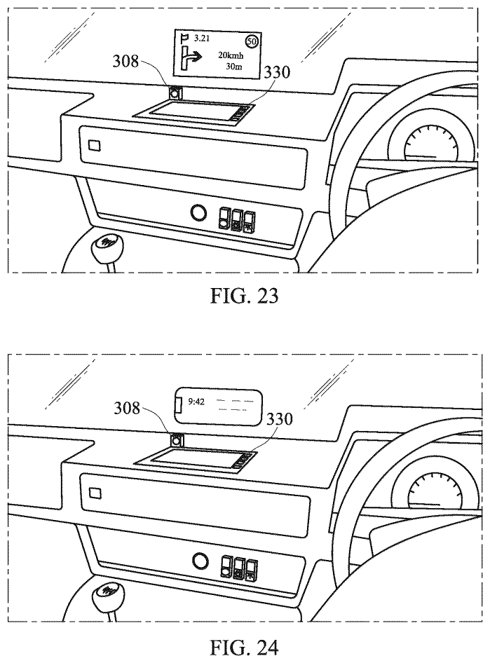

Referring to FIG. 23, there is illustrated a configuration of the smart tray assembly 300 integrated into the dashboard region of a vehicle, comprising an interface screen 330 and an artificial-intelligence (AI) camera module 308. The AI camera 308 is mounted either adjacent to the tray assembly or within its structural housing and is oriented toward the driver's seating area to maintain an unobstructed field of view. The AI camera 308 is configured to capture visual and infrared imagery for the purpose of device authentication, occupant identification, and behavioral monitoring. In particular, the AI camera 308 may detect the presence, placement, and authenticity of electronic devices (such as smartphones or tablets) within the cabin, ensuring that the authorized device is properly docked within the tray slot 320 before system activation.

In exemplary operation, the AI camera 308 continuously scans the vehicle cabin for unauthorized or decoy devices placed outside the designated docking area. When such a condition is detected, e.g., when a dummy phone is used to circumvent safety protocols, the SmartSafe system generates an alert notification which may be transmitted wirelessly to a monitoring entity, such as a fleet administrator, parental guardian, or designated supervisor, depending on the operational context. The AI module may also employ facial recognition, occupancy detection, or driver-profile verification algorithms to confirm that the appropriate user is operating the vehicle under the correct mode (e.g., Teen Mode, Fleet Mode, or Admin Mode). In certain embodiments, the AI camera 308 forms part of an integrated Advanced Driver Assistance System (ADAS), performing driver monitoring functions including drowsiness detection, eye-tracking, gaze assessment, and distraction recognition, thereby contributing to overall vehicle safety and compliance with behavioral policies.

In another embodiment, the smart tray assembly 300 operates in functional coordination with the vehicle's Head-Up Display (HUD) and infotainment system. Upon activation of the navigation icon or button presented on the interface screen 330, the SmartSafe control unit transmits navigation data concurrently to the HUD for line-of-sight display and to the infotainment screen for passenger reference. The HUD projection allows the driver to receive route information, turn-by-turn guidance, and ETA data without diverting attention from the roadway. Similarly, activation of the Bluetooth control icon initiates a wireless connection between the docked smartphone and the vehicle's infotainment platform, enabling hands-free calling, voice-based message management, and audio streaming. When an incoming message is received while the smartphone is docked, the system automatically displays the sender's name or contact identifier on both the HUD and infotainment screen. Simultaneously, an automated text response may be generated, politely informing the sender that the driver is operating the vehicle and suggesting a call instead of continued texting, optionally including the estimated time of arrival (ETA) derived from live navigation data.

In yet another embodiment, the navigation function can be initiated by voice command, eliminating the need for manual input. The interface screen 330 integrates a navigation icon or microphone indicator, which, when activated, enables voice-controlled address input. The driver may speak a destination, landmark, or route instruction, whereupon the system retrieves real-time navigation data via the paired smartphone or an onboard telematics server. The computed route map and turn-by-turn directions are then displayed either on the Head-Up Display (HUD) or the infotainment screen, depending on the driver's preference or pre-configured settings. This configuration allows the driver to maintain continuous visual focus on the road, ensuring that critical route guidance is presented in a non-distracting and context-aware manner.

In a further embodiment, selection of the music or media icon displayed on the interface screen 330 initiates a voice-activated media retrieval process. The system accepts an audio input specifying a desired song title, artist, or playlist, and retrieves the corresponding media either from the paired smartphone, a connected USB storage device, or a cloud-linked music service. Playback is automatically routed through the vehicle's infotainment audio system, with volume and playback controls remaining accessible via the screen or through voice command. This voice-based entertainment interface minimizes manual interaction, reduces driver distraction, and provides an intuitive, safe, and integrated method of accessing media content while driving.

Referring now to FIG. 24, there is illustrated a configuration showing the integration of a Head-Up Display (HUD) with the smart tray assembly 300 as part of the SmartSafe vehicle interface system. The HUD is optically aligned with the driver's forward line of sight and is configured to project critical driving information, such as current speed, navigation cues, time, safety alerts, and system notifications, directly into the driver's visual field. The projected image appears as a floating overlay above the dashboard, achieved through optical reflection or holographic projection techniques, thereby eliminating the need for the driver to divert gaze away from the roadway. This optical arrangement enhances situational awareness, reduces cognitive load, and supports real-time monitoring of key operational data while maintaining a safe driving posture.

In the illustrated embodiment, the interface screen 330 of the smart tray serves as a centralized control and configuration hub for managing HUD functionalities. When a electronic device 21 is securely docked within the tray and the system is active, the interface enables the driver to activate, customize, or synchronize HUD outputs according to operational preferences or contextual needs. The HUD may dynamically display navigation instructions, turn-by-turn route guidance, speed limits, driver alerts, ADAS warnings, or infotainment summaries, such as incoming call information, media playback details, and message notifications. In one embodiment, the HUD projects essential data such as time, navigation path, and communication alerts within the driver's eye line, while the infotainment display provides corresponding expanded views or secondary confirmation of the same data.

In another embodiment, upon receipt of an incoming text message, the infotainment display automatically presents the sender's identification along with an on-screen indicator confirming that an automated response will be transmitted. This response may include a request for the sender to place a call instead of continuing to text, along with the driver's estimated time of arrival (ETA) computed from real-time navigation data. The HUD may concurrently display a concise visual cue notifying the driver of the message receipt without requiring interaction. All such features are controllable through the smart tray interface, allowing the driver to enable, disable, or modify individual HUD and infotainment functions directly from the tray's touch or voice interface, thereby minimizing manual input through the main infotainment console.

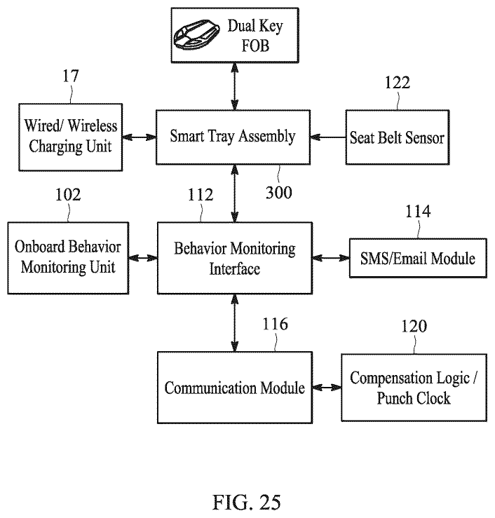

FIG. 25 illustrates a system-level block diagram of the enhanced Smart Tray Assembly forming part of the Smart Safe Console System 100. The system is configured to provide an integrated vehicle control and safety management platform that coordinates driver monitoring, operational interlocks, infotainment management, and usage-based compensation features. Through hardware and software subsystems, the Smart Safe Console system 100 enables safe, connected, and accountable driving behavior while maintaining ergonomic simplicity for the vehicle operator.

The Smart Tray Assembly 300 serves as the central control and logic unit of the system. It houses the microcontroller and communication circuits that interface with other vehicle and driver subsystems. The tray assembly is operatively coupled to a wired or charging unit 17, configured to automatically detect, authenticate, and secure the driver's smartphone 21 within the console compartment. Upon successful docking, the smartphone is electronically linked to the system for authentication, data exchange, and wireless power transfer. In certain embodiments, the tray docking station 19 supports dual smartphone docking, allowing simultaneous placement of two electronic devices, for example, to accommodate a driver and a co-driver or enable parent-teen paired monitoring. Each docked device may be independently recognized by the system, enabling differentiated access privileges or cooperative control modes.

The Smart Safe Console System 100 further includes a seat-belt sensor 122 that is electrically coupled to the Smart Tray Assembly 300. The seat-belt sensor 122 detects whether the driver's seatbelt is fastened, and communicates this signal to the tray controller. The system logic cross-verifies seat-belt engagement with smartphone docking and vehicle ignition status to determine whether normal vehicle operation can proceed. In one embodiment, the system inhibits transmission shift from “Park” to “Drive” until both the smartphone is properly docked and the seatbelt is confirmed fastened, thereby enforcing compliance with predefined safety interlocks.

A dual key-fob system is also integrated into the Smart Safe Console, comprising at least a Parent Key Fob and a Teen Key Fob, each carrying a unique digital identifier. The smart tray receiver module interprets the active key-fob signal to determine the corresponding operational mode. When the Teen Key Fob is detected, the console automatically activates a restricted-access mode, in which safety parameters are strictly enforced, such as limiting maximum volume levels, requiring full seat-belt engagement, and restricting infotainment access during motion. In contrast, the Parent Key Fob may grant administrative privileges, enabling configuration of monitoring thresholds, alert recipients, and vehicle permission settings.

To enable behavioral analytics, a Behavior Monitoring Interface 112 is communicatively linked to the Smart Tray Assembly 300. The interface collects and interprets real-time driving data from a Behavior Monitoring Unit 102, which may be integrated into the vehicle's onboard telematics or implemented as an external module. The behavior monitoring unit 102 tracks driving behavior parameters, including, but not limited to, lane departures without signaling, speed limit exceedance, harsh braking or acceleration events, mobile device interaction during driving, and excessive media volume. These parameters are continuously processed by the interface logic to assess compliance with safe driving norms and mode-specific restrictions.

Upon detection of one or more predefined violations, the Behavior Monitoring Interface 112 triggers an outbound alert protocol via the SMS/Email Notification Module 114. The module transmits immediate or periodic notifications to designated recipients such as parents, fleet administrators, or safety supervisors. In certain embodiments, the system may attach contextual metadata, such as a timestamp, vehicle speed, or GPS location, to enhance accountability and enable post-event review. These notifications support remote supervision and real-time behavioral feedback, particularly useful in teen driver safety programs or fleet management applications.

The system further incorporates a Communication Module 116 that serves as a gateway between the tray assembly, external networks, and backend cloud infrastructure. The module interfaces with both the Behavior Monitoring Interface 112 and a Compensation Logic Unit 120, also referred to as the “Punch Clock” module. The Punch Clock module computes usage-based compensation for commercial or professional drivers by correlating vehicle motion data with the duration of smartphone docking and system-active driving time. This data may be transmitted to remote servers through the Communication Module 116 for automated payroll processing, compliance reporting, or incentive-tracking purposes.

In certain embodiments, upon successful smartphone docking and driver authentication, the system activates the infotainment subsystem and establishes a secure link to a virtual assistant device 9 or compatible connectivity platforms such as Apple CarPlay, Android Auto, or vehicle-native OS interfaces. The infotainment functions may include navigation guidance, voice command processing, and media control, all of which can be governed or limited by the active driving mode (e.g., Teen or Fleet Mode). The combined functionality ensures seamless integration of safety, convenience, and accountability, positioning the Smart Safe Console system 100 as an intelligent, driver-aware vehicle interface platform.

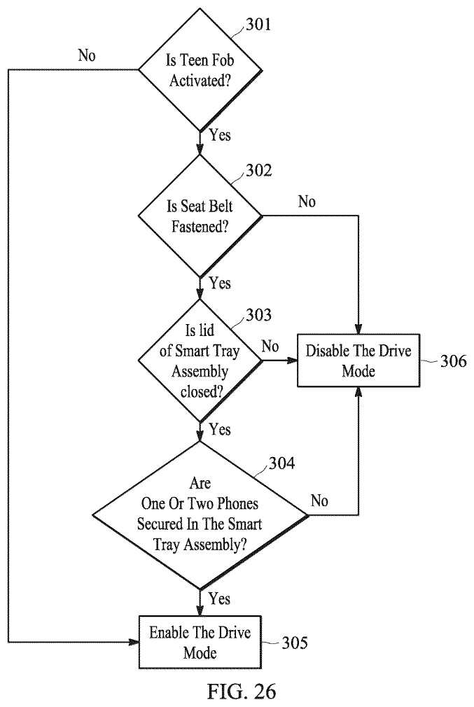

FIG. 26 illustrates a logic flow diagram representing the conditional interlock sequence executed by the vehicle's central control system when operating in Teen Driver Mode. This mode is automatically activated upon detection of a Teen Key Fob and governs the procedural logic for enabling or disabling vehicle drive mode. The flow ensures that multiple safety prerequisites are met before the vehicle can shift from “Park” to “Drive.” The system thus enforces structured, rule-based operation to promote responsible driving behavior among young or restricted drivers.

At the initial decision node 301, the control logic determines whether a Teen Key Fob has been activated. This signal is received via the dual key-fob receiver system integrated with the Smart Tray Assembly 300. If the signal corresponds to a Parent Key Fob or a fleet supervisor fob, the logic branches to a separate control path that allows standard or administrator-authorized driving conditions, bypassing certain interlocks. Conversely, if the system detects the Teen Key Fob, the “Yes” path is followed, triggering enhanced monitoring and safety verification protocols unique to Teen Driver Mode.

Upon confirmation of the Teen Key Fob, the system proceeds to decision block 302, where it evaluates the status of the seat-belt sensor 122. The sensor communicates with the Smart Tray Controller to verify whether the driver's seatbelt is securely fastened. If the seatbelt is unfastened (No path), the control logic immediately invokes Command 306, which disables the “Drive” state and retains the vehicle in the “Park” position. In certain embodiments, the system may also generate an audible chime or visual alert on the interface screen 330 to prompt the driver to fasten the seatbelt before retrying.

If the seatbelt is detected as fastened (Yes path), the logic advances to decision node 303, where it verifies the closure status of the dual-wing tray lid assembly, consisting of the left-wing 13 and right-wing 14 of the Smart Tray Assembly 300. Each wing is equipped with a micro-sensor or magnetic latch detector configured to send closure confirmation signals to the system controller. The interlock requires both wings to be securely closed, ensuring that the smartphone(s) remain safely enclosed and inaccessible during driving. If either wing is not closed (No path), the logic executes Command 306 to maintain the “Park” state, accompanied by a user alert on the interface display indicating “Tray Open—Drive Disabled.”

If the tray wings are confirmed closed (Yes path), the system continues to decision block 304, where it verifies the docking status of one or more smartphones within the charging unit 17 of the Smart Tray Assembly 300. This step ensures that the driver's authorized device is properly docked and registered. In certain embodiments, dual docking verification is supported, allowing parental or supervisory control policies to mandate the presence of both a primary (teen) and secondary (parent) smartphone before enabling drive mode. The system may authenticate the docked devices via Bluetooth pairing, NFC, or device ID recognition. If the required smartphone(s) are not detected or fail authentication (No path), Command 306 is again triggered, disabling vehicle drive engagement and maintaining the interlock condition.

Only when all predefined safety conditions are satisfied, including activation of the Teen Key Fob, confirmation of seat-belt engagement, closure of both tray wings, and successful docking of the required smartphone(s), does the logic proceed to the terminal block 305. At this stage, the controller issues an “Enable Drive Mode” command, authorizing the gear shift actuator to move from “Park” to “Drive.” The transition is typically accompanied by a visual confirmation message on the interface screen 330 or Head-Up Display (HUD), indicating “All Conditions Met—Drive Authorized.” In alternative embodiments, the system may log this event for audit or parental notification purposes, thereby creating a verifiable record of compliance before the start of each driving session.

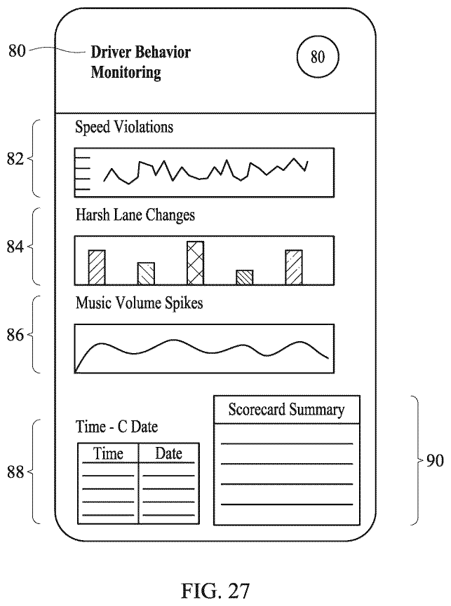

FIG. 27 illustrates an exemplary Dashboard Interface 80 for Driver Behavior Monitoring, which is configured for display on a mobile device, tablet, cloud-based web portal, or in-vehicle infotainment screen. The dashboard interface 80 forms part of the Behavior Monitoring Interface 112, functionally coupled with the Smart Tray Assembly 300, the Communication Module 116, and optionally the Cloud Analytics Server. Together, these modules enable real-time capture, analysis, and reporting of driver performance and behavioral trends during vehicle operation, particularly when operating under Teen Driver Mode or a Fleet Monitoring Mode.

The Dashboard Interface 80 is organized into multiple data visualization segments, each configured to present specific behavioral metrics in a clear and actionable format. These segments collectively provide a comprehensive overview of driving style, adherence to safety protocols, and potential risk factors. The system may operate in real-time display mode or retrospective report mode, depending on the user or administrator's access level. The data may be refreshed continuously or in predefined intervals, with information sourced from the Behavior Monitoring Unit 102, ECM (Engine Control Module), steering angle sensors, and infotainment system telemetry.

A first data segment 82 presents a time-series graph depicting speed violation patterns over a selected duration. The y-axis corresponds to vehicle speed relative to the posted limit, and the x-axis represents temporal intervals, such as minutes or hours of a driving session. Spikes or abrupt inflections in the plot represent instances of exceeding threshold speeds. These are derived from vehicle speed sensors, onboard GPS, or telematics data streams. Each violation point may be interactively selectable to display contextual information, such as the road name, speed limit exceeded, and GPS coordinates of occurrence.

A second visual block 84 represents a bar graph visualization of harsh or unsafe lane changes, indicative of erratic driving maneuvers or inattentive operation. Each bar may correspond to an individual event categorized by time of day, road type, or traffic conditions. The events are logged automatically based on inputs from steering angle sensors, accelerometers, and lane departure sensors. In some embodiments, color coding is applied to distinguish between moderate, severe, or high-risk lane deviations. These metrics serve as indicators of driver discipline and responsiveness under monitored conditions.

A third visual segment 86 displays music or infotainment volume fluctuations, illustrating behavioral tendencies correlated to distraction or emotional driving states. The system captures these spikes through integration with the vehicle's infotainment or audio control system and associates each variation with timestamped driving data. In one embodiment, the interface highlights correlations between elevated volume and concurrent speeding or steering deviations, thereby providing a holistic behavioral interpretation of the driver's engagement or stress levels.

A time-stamped activity log 88, located in the lower-left quadrant of the dashboard, provides a chronological list of behavioral events and key operational data. Each entry is marked with a “Time—C Date” label, indicating precise timestamps and corresponding calendar dates. The activity log is automatically compiled by the Behavior Monitoring Interface 112, with data securely transmitted to and stored in either local onboard memory or cloud storage via the Communication Module 116. In certain embodiments, the log supports export to external systems for auditing, parental review, or integration with fleet management platforms.

In the lower-right quadrant, a Scorecard Summary 90 is presented, offering a quantitative or qualitative safety rating for the driver. The score is dynamically calculated using a weighted algorithm that accounts for frequency, severity, and recency of violations, such as speeding, harsh braking, or distraction indicators. The system may express this score as a numerical index, color-coded grade, or percentile ranking relative to previous performance periods. In commercial or insurance-based applications, this scorecard can be shared with fleet supervisors, insurance providers, or parents to support reward-based safety programs, usage-based insurance (UBI) schemes, or driver training recommendations.

Overall, the Dashboard Interface 80 functions as an integrated behavioral analytics tool that enables continuous monitoring, evaluation, and documentation of driver performance in real time or retrospectively. The dashboard empowers parents, fleet managers, or safety administrators to identify behavioral trends, enforce compliance with safety policies, and maintain an objective record of driving patterns. In certain embodiments, the interface may further support AI-driven predictive analysis, automatically generating alerts or improvement suggestions based on recurring behavioral anomalies, thereby enhancing both safety and accountability within the monitored vehicle ecosystem.

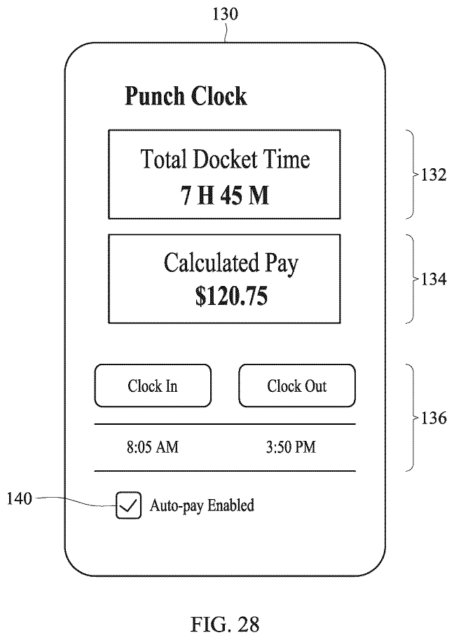

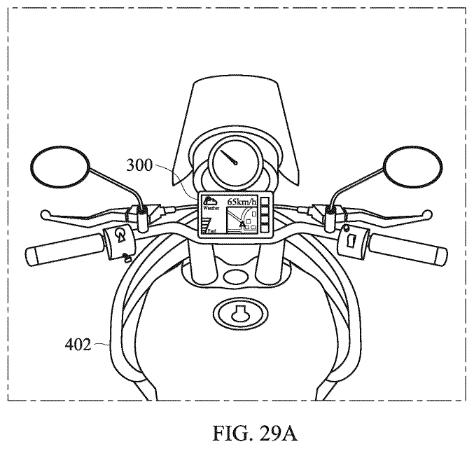

FIG. 28 illustrates a Graphical User Interface (GUI) display 130 for the Punch Clock Module, which forms part of the Compensation Logic Unit 120 described in FIG. 5. This module is particularly suited for commercial or fleet vehicle applications, where driver work hours are tracked and compensation is computed based on the duration for which the driver's smartphone remains securely docked within the charging unit 17 of the Smart Tray Assembly 300.

The GUI display 130 includes a header labeled “Punch Clock”, serving as the module identifier. Directly below the header, a primary display section 132 presents the Total Docked Time, exemplified as “7 H 45 M.” This value reflects the cumulative duration during which the driver's smartphone has been docked and the vehicle has been operational, as detected by the SmartSafe system. The system can optionally differentiate between active driving time and idle periods to provide precise work-hour tracking.

Beneath the total docked time, the interface displays Calculated Pay 134, shown in this embodiment as “$120.75.” The calculation is derived from predefined hourly wage rates stored in system memory and may incorporate bonuses, multipliers, deductions, or performance-based adjustments based on driver behavior metrics or vehicle-specific parameters. In some embodiments, the pay computation can integrate compliance with fleet policies, adherence to safety standards, or utilization of approved routes.

The interface includes interactive Clock In and Clock Out buttons 136, allowing drivers to manually initiate or terminate tracked sessions. In alternative embodiments, these actions may be automated based on ignition state, smartphone docking detection, or app login events, ensuring seamless time capture without requiring driver intervention.

A timestamp panel is located beneath the control buttons, displaying exact clock-in and clock-out times, such as “8:05 AM” and “3:50 PM.” These entries are securely logged within the system for audit purposes, payroll processing, and regulatory compliance. The log may be accessible through the mobile application, in-vehicle infotainment system, or a backend fleet management dashboard.

At the bottom of the interface, an Auto-Pay Checkbox 140 allows the driver or administrator to enable or disable automatic compensation disbursement. When enabled, the Punch Clock module transmits time and pay data via the Communication Module 116 for backend processing, seamlessly integrating compensation with behavior and usage tracking.

This interface is implemented via the SmartSafe mobile application or in-vehicle infotainment unit, providing an integrated solution linking driver behavior, vehicle use, and monetary compensation. The system thereby supports a monetized, usage-based tracking model, enhancing accountability and transparency in commercial or fleet operations.

In another embodiment, the SmartSafe Console System incorporates an anti-theft synchronization feature to ensure secure authorization of the smartphone before vehicle operation. The interface screen 330 of the cassette player tray includes a Sync icon 312. When the driver taps the Sync icon, the system generates a unique, time-sensitive anti-theft code, which may be produced by the console's embedded controller using encryption algorithms, random number generation, or cloud-based authentication services.

Upon receipt of the anti-theft code, the driver's smartphone displays the code within a companion application, and the driver may enter the code manually or use supported copy/paste functionality. Once the code is validated, the smartphone displays a confirmation message such as “Authorization Granted” or “Cassette Player Unlocked.”

Following successful authorization, the driver inserts the smartphone into the cassette player tray using a push-push docking mechanism, which securely locks the device in place. Only after proper docking of the authorized smartphone does the system permit the vehicle to start and shift into drive. This embodiment adds a layer of security, preventing unauthorized access or vehicle operation in the absence of a verified device.

In certain embodiments, the authorization process is repeated each time the vehicle ignition is cycled. In others, the system may retain authentication for a predefined duration or until the smartphone is removed from the tray. The anti-theft code may be transmitted via secure channels, including encrypted Bluetooth, Wi-Fi Direct, or near-field communication (NFC), thereby ensuring data integrity, resistance to spoofing, and robust protection against unauthorized vehicle use.

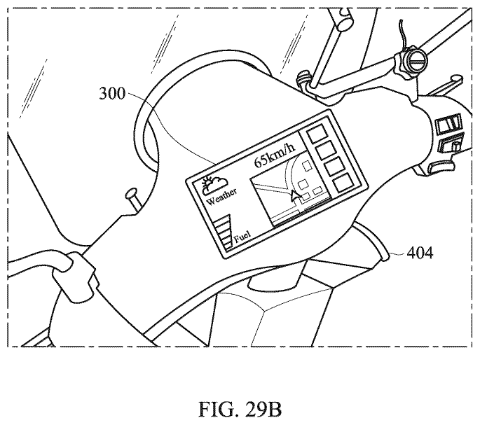

FIGS. 29A and 29B illustrate an embodiment of the Smart Tray Assembly 300 adapted for use in a two-wheeler, such as a motorcycle 402 or scooter 404. In this embodiment, the tray assembly 300 is securely mounted on the handlebar assembly of the motorcycle 402 or scooter 404, allowing the rider to conveniently dock a smartphone prior to initiating vehicle operation. The assembly is designed to maintain stable positioning under dynamic riding conditions, ensuring reliable docking and device security.

The tray assembly 300 is positioned centrally on the handlebars, within the rider's direct line of sight, facilitating intuitive interaction. The front-facing display screen provides navigation cues, notifications, and system status updates such as docking confirmation, battery status, or vehicle lock state. In this configuration, the motorcycle or scooter is interlocked with the tray assembly, such that the vehicle will not start unless the rider's smartphone is securely docked, thereby enhancing both rider safety and anti-theft protection.

In certain embodiments, the tray assembly 300 is constructed from durable carbon fiber material, offering lightweight strength, impact resistance, and long-term durability. The unit further incorporates a waterproof and anti-glare design, ensuring operability under rainy conditions and direct sunlight. For additional environmental protection, the system may include a protective cover or miniature umbrella, shielding the docking interface from inclement weather and debris.

The tray assembly 300, when mounted on the motorcycle handlebar, is additionally configured to display navigation information directly on the front façade, providing the rider with turn-by-turn directions without diverting attention from the road. Furthermore, the system integrates with onboard AI-powered cameras or sensors to monitor rider drowsiness, intoxication, or inattentiveness. Alerts can be provided in real-time to the rider, and data may be transmitted to remote stakeholders, such as fleet managers, parents, or other registered users, supporting safety monitoring and compliance.

This embodiment demonstrates the adaptability of the SmartSafe system for two-wheelers, including motorcycles and scooters, while retaining the safety, monitoring, and smartphone-docking functionalities described for four-wheeler implementations. The design ensures secure device handling, real-time rider feedback, and operational interlocks, thereby extending SmartSafe's features across vehicle classes while preserving usability and rider focus.

It is understood that when an element is referred to hereinabove as being “on” another element, it can be directly on the other element, or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents. Implementations may also include one or a combination of any two or more of the aforementioned features or embodiments.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

The disclosure is illustrated throughout the written description. It should be understood that numerous variations are possible while adhering to the inventive concept. Such variations are contemplated as being a part of the present disclosure.

1. A smart tray assembly for a vehicle, comprising:
a housing defining a docking slot configured to receive and retain a smartphone;
a controller operatively coupled to the docking slot and to the vehicle ignition system, the controller being configured to permit the vehicle to start or shift from park to drive only when the smartphone is securely docked;
a voice-interactive interface configured to project navigation and media data from the smartphone onto at least one of a head-up display (HUD), helmet display, or vehicle infotainment screen; and
a sensory alert system comprising at least one of an audible speaker and a visual indicator light configured to emit a beeping sound or flashing color alert when a route update, fuel-level warning, or safety notification is generated.

2. The smart tray assembly of claim 1, further comprising a seatbelt detection module configured to detect fastening of a seatbelt, wherein the controller enables the vehicle start only when both the smartphone is securely docked and the seatbelt is fastened.

3. The smart tray assembly of claim 1, further comprising a dual key-fob system including:
a first key fob configured for unrestricted operation; and
a second key fob configured to activate a restricted mode requiring smartphone docking, seatbelt fastening, and optionally behavior monitoring before enabling drive mode.

4. The smart tray assembly of claim 3, wherein the restricted mode is associated with a Teen or Fleet Driver key fob and is configured to monitor driver behavior, including speeding, harsh acceleration or braking, unsafe lane changes, and elevated audio levels, and to transmit alerts or reports to a parent, fleet manager, or insurance provider.

5. The smart tray assembly of claim 1, wherein the HUD employs a color-coded alert scheme including:
a red illumination indicating an available new route;
a yellow illumination indicating a low-fuel condition with automatic generation of directions to a nearest fueling station; and
a blue illumination indicating compliance with current speed limits.hands-free.

6. The smart tray assembly of claim 1, wherein the system is compatible with HERE navigation technology, and is configured for use by truck, rideshare, or delivery drivers for real-time route guidance.

7. The smart tray assembly of claim 1, wherein the assembly further comprises a rotary knob for controlling system audio volume and a dedicated voice-activation button enabling the driver to issue hands-free commands, including navigation requests, phone calls, and music playback.

8. The smart tray assembly of claim 1, wherein the infotainment icons, including navigation, music, phone, and system controls, are digitally displayed on a façade portion of the cassette player and are activatable via touch or haptic feedback without requiring visual confirmation by the driver.

9. The smart tray assembly of claim 1, further comprising an anti-theft synchronization module configured to generate a unique time-sensitive authorization code upon receipt of a sync input, transmit the code to a driver's smartphone, and unlock the docking slot only after successful validation of the code.

10. The smart tray assembly of claim 1, further comprising an internal speaker configured to output voice prompts corresponding to system notifications, route updates, and AI dialogue, wherein the driver can verbally respond with “yes” or “no” to confirm or decline navigation changes, and the speaker issues an audio reminder to retrieve the smartphone after vehicle shutdown.

11. The smart tray assembly of claim 1, wherein the assembly is mountable to a handlebar or dashboard of a motorcycle, scooter, or e-bike, and the vehicle engine is prevented from starting unless the smartphone is docked, wherein navigation data is projected onto the windshield or helmet-mounted HUD.

12. The smart tray assembly of claim 1, wherein the assembly comprises a waterproof, heat-resistant, and anti-glare outer enclosure made from carbon fiber or composite material, and includes a protective cover or umbrella element for rain protection.

13. The smart tray assembly of claim 1, further comprising:
a cooling fan configured to regulate smartphone temperature;
an AI-enabled camera configured to detect dummy or unauthorized smartphones and issue a tamper alert; and
a tinted or opaque glass lid configured to obscure the smartphone screen from the driver during operation.

14. The smart tray assembly of claim 1, wherein the docking mechanism includes at least two smartphone slots, and the controller is configured to enable the vehicle drive mode only when both smartphones are securely docked, each associated with an authorized driver or passenger.

15. The smart tray assembly of claim 1, wherein the controller is further configured to communicate with an Advanced Driver Assistance System (ADAS) and generate automatic alerts or safety interventions based on environmental or behavioral conditions.

16. The smart tray assembly of claim 1, wherein the assembly includes an event data recorder configured to log driving activity, route changes, voice interactions, and safety events for diagnostic or evidentiary purposes.

17. The smart tray assembly of claim 1, wherein the controller is configured to interface with home automation systems and perform remote control functions, including garage-door opening, lighting control, or appliance adjustment upon docking of the smartphone.

18. The smart tray assembly of claim 1, wherein the system requires, before enabling vehicle start, (a) fastening of a seatbelt, (b) successful completion of an AI-based eye scan or sobriety test performed through the smartphone camera, and (c) completion of a touchscreen-based reaction-time test.

19. The smart tray assembly of claim 1, wherein the internal material of the docking slot is molded from neoprene or similar synthetic rubber designed to cushion and retain the smartphone during wireless charging.

20. The smart tray assembly of claim 1, further comprising a backup emergency start mechanism located within the vehicle, activation of which requires remote authorization by a parent or fleet manager through a secure mobile interface, and a green light indicator confirming start enablement after authorization.
